(19) United States
(12) Patent Application Publication
(10) Pub. No.: US 2023/0397609 A1
(43) Pub. Date: Dec. 14, 2023

(54) PESTICIDE MICROEMULSION COMPOSITIONS

(71) Applicant: BASF SE, Ludwigshafen (DE)

(72) Inventors: Murat Mertoglu, Limburgerhof (DE); Gina Nash, Limburgerhof (DE)

(21) Appl. No.: 18/033,418

(22) PCT Filed: Oct. 26, 2021
(86) PCT No.: PCT/EP2021/079661

§ 371 Date: Apr. 24, 2023

(30) Foreign Application Priority Data
Oct. 27, 2020 (EP) 20204093.7

(51) Int. Cl. A01N 57/20; A01N 43/10; A01N 25/30; A01N 25/04; A01N 25/22

(52) U.S. Cl. CPC A01N 57/20; A01N 43/10; A01N 25/30; A01N 25/04; A01N 25/22

(57) ABSTRACT

The present invention relates to a stable agrochemical composition in form of a microemulsion comprising a watersoluble pesticide and a water insoluble pesticide together with a specific combination of organosulfate surfactant components for use in agricultural application methods.

The present invention relates to a stable agrochemical composition in form of a microemulsion comprising a water-soluble pesticide and a water-insoluble pesticide together with a specific combination of organosulfate surfactant components for use in agricultural application methods.

Further objects of the present invention are methods for controlling undesirable vegetation, which method comprise applying the microemulsion formulation to a locus where undesirable vegetation is present or is expected to be present; the use of the combined organosulfate surfactant components for increasing the stability of the aqueous agrochemical compositions comprising the water-insoluble pesticidal active and the water-soluble pesticide (or a salt thereof); a method of producing the agrochemical microemulsion composition comprising the step of mixing the organosulfate surfactant components with the water soluble herbicide (or a salt thereof) and the water insoluble pesticide; plant propagation material comprising the pesticidal microemulsion composition; and to a method for treating plant propagation material comprising the step of treating plant propagation material with the pesticidal microemulsion composition.

### FIELD OF INVENTION

Some organic agrochemical active compounds, like herbicides, fungicides, insecticides—or pesticides in general—are often applied in the form of a dilute aqueous composition in order to achieve a good interaction with the target organisms, which can be weeds, fungi or pests like invertebrate pests. Whereas some of these agrochemical actives are water soluble, a considerable amount of organic pesticide compounds are only sparingly or even insoluble in water. To prevent resistance development and to combine different mode of actions, farmers are interested in getting formulated products that contain different actives. In some cased, this requires that water-soluble actives or their active salts must be formulated together with non-ionic water immiscible actives or sparely water miscible actives. Therefore, formulators are often confronted with difficulties in formulating agrochemical compounds in aqueous formulations that can be easily diluted with water.

Organic pesticides having a limited solubility in water are often formulated as wettable powders or granules, as emulsifiable concentrates (EC) or as aqueous suspension concentrates (SC) which can be diluted with water for use in the field.

Suspension concentrates are formulations, wherein the active ingredient is present in the form of finely divided solid particles which are suspended in an aqueous dispersing medium utilizing surface-active compounds (surfactants), such as wetting agents, dispersants and rheological or suspending aids for stabilizing the active ingredient particles in the dispersing medium. However, problems are often encountered with SC's as a result of settling during prolonged storage or storage at elevated temperatures, the resistance of settled particles to re-suspension and the formation of crystalline material upon storage. As a consequence, the formulations are difficult to handle and the bio-efficacy may be inconsistent which is in particular problematic for highly active modern pesticides. Moreover, SC's are limited to actives that have a relatively high melting point. Most agrochemicals are sparingly water-soluble and become partly “deactivated” with water when formulated as an aqueous SC.

In wettable powders or granules the pesticide compound is present in the form of particles. When wettable powders or granules are diluted in water for field application, the particles of the powder or granules have to disintegrate in water to achieve a uniform distribution of the pesticide compound in the aqueous dilution. Unfortunately, disintegration of the particles is often hampered, if the solid formulation has been stored for prolonged time or in opened packages. Hindered disintegration may result in inconsistent bioefficacy.

Emulsifiable concentrates are non-aqueous liquid formulations, where the pesticide compound is dissolved in a mixture of non-polar organic solvents and emulsifiers. Upon dilution of emulsifiable concentrates with water, an oil-in-water emulsion is formed. Unfortunately, emulsifiable concentrates tend to be instable upon storage, as the surfactants and the solvents may suffer phase separation. As a result, emulsification in water may be hampered which may again result in inconsistent bioefficacy. Apart from that, the large amounts of non-polar solvents may be undesirable from hygiene, environmental safety and health protection at workplace.

Aqueous multiphase formulations, wherein the pesticide compound is dissolved in an organic phase, such as microemulsions (also termed ME formulations), principally circumvent some of the aforementioned disadvantages. Microemulsions are multiphase systems which may comprise a disperse phase and a continuous phase or which may have bi-continuous structures with intricate channels of oily and aqueous phases. Due to the small particle size (droplet size) of the disperse phase, or the intricate channels, microemulsions have a translucent appearance.

### BACKGROUND OF THE INVENTION

As mentioned above, microemulsions are clear, isotropic thermodynamically stable liquid dispersion wherein the dispersed domain diameter varies approximately from 1 to 100 nm, usually 10 to 50 nm.

The microemulsions are in general mixtures of a non-aqueous water immiscible dispersed liquid phase, an aqueous water phase and surfactant (frequently in combination with co-surfactants).

In microemulsions, where two immiscible phases (aqueous and non-aqueous phases) are present together with surfactants, the surfactant molecules may form a monolayer at the interface between the oil and water, with the hydrophobic tails of the surfactant molecules dissolved in the non-aqueous phase and the hydrophilic head groups in the aqueous phase.

In pesticide applications, the non-aqueous water immiscible dispersed liquid phase contains water immiscible liquid actives, and/or active(s) which is solubilized in water immiscible solvents and or oils. Even water immiscible liquid actives can be mixed with other water immiscible solvents and or oils as required. The aqueous phase may contain salt(s), water soluble actives, their active salt(s) and/or other water-soluble ingredients.

In contrast to ordinary emulsions, microemulsions form upon simple mixing of the components and do not require the high shear conditions generally used in the formation of ordinary emulsions, and the average distance of adjacent phase boundaries, e.g. the droplet size of the disperse phase or the diameter of the channels (Z=average diameter as determined by light scattering) is at least 5 times smaller than in macro emulsions and generally does not exceed 200 nm, while the average diameter of the droplets in macro emulsions is in μm range.

In case water soluble actives or their active salts must be formulated together with non-ionic water immiscible actives or sparely water miscible actives, that poses a real challenge for the formulation chemists because typical surfactants and dispersing agents precipitates and become insoluble in water because of increased ionic strength which caused by salts and active salts. Hence the development of stable suspension, microemulsions, and/or emulsion concentrates is a perpetual challenge.

WO 2009/019299 describes ME formulations of sparingly water soluble insecticide compounds, which, besides water and the insecticide compound, at least one polar organic solvent selected from ketones, esters, amides and ethers, each having from 6 to 8 carbon atoms, at least one alcohol having 6 to 8 carbon atoms, a water immiscible solvent and one or more surfactants.

WO 2009/133166 describes ME formulations of pesticide compounds which, besides water and the pesticide, contain at least one organic solvent which is completely miscible with water, at least one organic solvent which is partially miscible with water, in particular a fatty acid amide and at least one non-ionic surfactant which usually includes at least two different surfactants having a poly-C₂-C₄-alkylene ether group.

WO 2015/147024 describes a composition for preparing an emulsion or a microemulsion containing the component (A): an active component having a solubility of 200 ppm or less in 20′C water; the component (B): a non-water-soluble solvent having no alcohol groups; the component (C): at least one non-ionic surfactant selected from the group consisting of polyoxyalkylene alkyl ether, polyoxyalkylene alkenyl ether, polyoxyalkylene alkyl amino ether, and polyoxyalkylene alkenyl amino ether; and component (D): a C₈-C₁₂ monohydric alcohol

EP 2 433 987 describe compositions for preparing emulsion or microemulsion formulations that demonstrates favorable dilution properties without being affected by the solubilities of constituent components. The compositions for preparing emulsion or microemulsion formulations contain a component (A): a polyoxyalkylene allyl phenyl ether, polyoxyalkylene aralkyl phenyl ether or polyoxyalkylene aralkenyl phenyl ether, a component (B): a polyoxyalkylene sorbitan alkyl ate, a component (C): a dialkylsulfosuccinate, and a component (D): an ester etherbased solvent.

US 20215/0344905 describes funcidial compositions comprising a strain of Bacillus subtilis or Bacillus amyloliquefaciens and an anionic emulsifier having a linear alkyl radical in a synergistically effective amount.

U.S. Ser. No. 10/716,304 describes a liquid herbicida composition comprising 20 to 25% of a a watersoluble herbicidal compound, a C₁₂-C₁₆ alkyl ether sulfate, an organic solvent and an alkyl polyglucoside.

EP371212 describes a herbicidal aqueous-based microemulsion comprising on a weight to volume basis about 20% to 40% of difenzoquat; about 5% to 25% of at least one essentially water insoluble active ingredient; about 5% to 40% of at least one nonionic surfactant; and 0% to about 25% of adjuvants.

WO 96/22692 describes synergistic herbicidal combinations of glufosinate and nitrodiphenylether, such as oxyfluorfen, and formulations thereof, such as emulsions. The formulations preferably contain an emulsifier combination comprising polyvinyl alcohol, phosphated EO/PO poclcopolys, dodecylbenzene sulfonate calcium and fatty alcohol polyglycol ethers.

CN 106359445 describes a microemulsion containing glufosinate ammonium and fluoroglycofen, a solvent, a co-solvent and a surfactant, which preferably a combination of alcohol ether glycoside (AEG), alkyl phenol formaldehyde resin polyoxyethylene ether, fatty alcohol polyoxyethylene ether sulfosuccinate monoester disodium salt and alkyl phenol polyoxyethylene ether sulfate ammonium salt.

CN 107156171 describes a pesticide micro-emulsion containing glufosinate-ammonium and fluoroglycofen-ethyl is characterized in that the micro-emulsion consists of the following components in percentage by weight: the parts by weight ratio of glufosinate and fluoroglycofen-ethyl are 10:1-1:10, the sum of the weights of glufosinate and fluoroglycofen-ethyl is 1% to 30% by weight, and the remaining components are 3% to 20% of solvent, 3% to 10% of an emulsifier, 1% to 15% or a synergist.

CN 108112584 describes a microemulsion containing tribenuron-methyl, benthiocarb, ethanol and an alkylsodium sulfate.

There is an ongoing need to find additives or certain combination of additives for agrochemical formulations that may enhance the biological effectivity of the composition and/or increase its physical and/or chemical stability and/or increase the loading of agrochemical composition with active ingredients and/or adjuvants. There are several advantages linked to these improvements. For instance, increased biological effectivity allows for lower application rates of the active ingredient, which reduces costs and health risks for the user. Higher loading of agrochemical compositions reduces the weight of a given packaging unit, thereby facilitating transportation and handling of the canisters containing the agrochemical compositions. Furthermore, a better physical and/or chemical stability increases the shelf life of the product, which is of relevance for storage and/or facing difficult climate conditions. Agrochemical compositions with higher loading of agrochemical active ingredients and/or adjuvants suffer from stability problems, such as gelling, flocculation, and creaming. Furthermore, agrochemical compositions with higher loading often have a high viscosity, which negatively affects their handling by the applicant or user of such composition, for instance the farmer. Improvements of individual effects on the one side may lead to negative effects on the other, which need to be balanced. Thus, adjusting agrochemical formulations for their agricultural use is a continuous challenge and causes constant tasks, which needs to be addressed during development.

Especially, regarding the stability of the ME formulations, these are not always satisfactory and unmixing (separation) or crystallization of the pesticide may occur. Moreover, dilution stability of ME formulations is sometimes insufficient, i.e. the sparingly water-soluble pesticide ingredient tends to segregate upon or after dilution with water, in particular, when the formulation is highly loaded with the pesticide ingredient. A further problem is that certain types of solvents which provide stable ME formulations, may be problematic in view environmental requirements and working hygiene. As mentioned above, very often micro-emulsions are prepared by mixing aliphatic alcohols with the non-aqueous phase. However, if the aqueous phase contains high content of active ingredient salt(s), the aliphatic alcohols become insoluble and can therefore not be used to prepare micro emulsions.

Consequently, it is difficult to develop stable formulations of water-soluble agrochemical active salts like the ones of the herbicides glufosinate, as for instance glufosinate-ammonium or glufosinate potassium, dicamba salts, glyphosate salts together with sparely water miscible, or immiscible active ingredients.

### SUMMARY OF INVENTION

Surprisingly it was now found that a specific combination of certain types of organosulfate compounds, such as linear alkyl ether sulfates combined with branched alkyl sulfates and/or branched alkyl ether sulfates provide stable microemulsions which are even stable if the continuous phase contains high concentration of electrolyte salts and/or active ingredient salts.

For example, it was found that stable microemulsions of an herbicidal active such as glufosinate-ammonium (in the aqueous phase) and dimethenamide-p (in the non-aqueous phase) could be developed by using the combinations of surfactants according to the present invention. Thus, the combination of organosulfate surfactants as disclosed hereinafter is suitable to develop microemulsions comprising a water insoluble active in the non-aqueous phase and water-soluble salts and/or agrochemical active salts in the aqueous phase.

It is the objective of the present invention to provide pesticidal, especially herbicidal compositions, comprising in addition to a water-soluble pesticide a water insoluble pesticide and that have an enhanced physical and/or chemical stability, and can optionally have high loading with agrochemical active ingredients and/or adjuvants and at the same can be easily handled and applied by the users, especially the farmers.

This objective is achieved by combining linear alkyl ether sulfates of the formula (I) with branched alkyl sulfates and/or branched alkyl ether sulfates of the formula (II).

Accordingly, the invention relates to a liquid aqueous agrochemical composition in form of a microemulsion comprising
(A) A combination of at least one pesticide A1 and at least one pesticide A2, where
   (A.1) is a water-soluble pesticide, and
   (A.2) is a water insoluble pesticide and
(B) a mixture of at least two organosulfate surfactant components, wherein
   (B.1) at least one organosulfate surfactant is selected from compounds of formula (I):

[R-(A)ₓ-OSO₃⁻]-M⁺ (I),
wherein
R is a linear radical selected from C₁₀-C₁₆-alkyl, C₁₀-C₁₆-alkenyl or C₁₀-C₁₆-alkynyl, and
X is a number selected from 1 to 10;
and
(B.2) at least one organosulfate surfactant is selected from compounds of formula (II)

[R^{a}-(A)_{y}OSO₃⁻]-M⁺ (II);
wherein
R^{a} is a branched radical selected from C₈-C₂₀-alkyl, C₈-C₂₀-alkenyl, or C₈-C₂₀-alkynyl, and
Y is 0 or a number selected from 1 to 10; and
wherein in formulae (I) and (II), independently from one another,
M⁺ is a monovalent cation selected from the group of alkali metal ions, NH₄⁺ and an ammonium salt of a primary, secondary or tertiary amine having a molecular weight of from 32 to 180 g/mol, or a mixture thereof;
A is a group of the following formula (i)

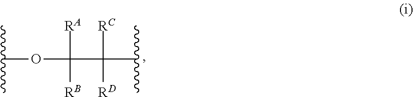

wherein
the oxygen atom in formula (i) is bound to a carbon atom in
R in formula (I), or respectively
R^{a} in formula (II); and
R^{A}, R^{B}, R^{C} and R^{D} are selected from H, CH₃ or CH₂CH₃, with the proviso that the sum of C-atoms of R^{A}, R^{B}, R^{C}, and R^{D} is 0, 1 or 2.

The microemulsions according to the present invention are clear, thermodynamically stable liquid dispersions, in which the dispersed main diameter varies approximately from 1 to 100 nm, usually 10 to 50 nm. The existence and the stability of a microemulsion can easily be evaluated visually when a water immiscible active ingredient is added into an aqueous pesticide formulation. If a non-appropriate surfactant combination is used and no stable microemulsion can be obtained, and the microemulsion becomes remains turbid, and/or phase-separation can be observed over storage. The resulting mixture becomes at least a two-phase system.

Moreover, the stability of microemulsions are highly dependent on temperature as they are thermodynamically stable systems. They can be prepared without strong agitation at a given temperature, but they can also immediately separate in phases if the system becomes thermodynamically instable due temperature change. A microemulsion, which is stable at 25° C., may therefore not be stable at other temperatures depending on the chosen surfactant combination. Different temperatures over the storage time may cause that the mixture may become turbid and phase-separation is observed.

Thus, considering the usage and storage of pesticides mixture formulations under real agricultural conditions and applications, it is not sufficient to develop a pesticide composition, which is stable only at room temperature. Pesticidal formulations are in general applied between 0° C. and 50° C. depending on the climate condition. Therefore, a microemulsion for pesticidal use must be stable at a larger temperature range. The microemulsion of the present invention comprising the inventive surfactant combination described herein is particularly suitable for this purpose. Products comprising such combination are shown to be stable in a range between 0° C. and 50° C.

### DETAILED DESCRIPTION OF THE INVENTION

The terms “compounds of formula (I)” and “compound of formula (I)” as used hereinbefore and hereinafter have the same meaning and refer to a situation in which at least one compound of formula (I) is present. Same applies to “compounds of formula (II)” and “compound of formula (II)”.

In general, terms mentioned in their plural form refer to a situation wherein only the singular term applies as well unless specifically expressed otherwise.

The organic moieties groups mentioned in the above definitions of the variables are—like the term halogen—collective terms for individual listings of the individual group members. The prefix Cₙ-Cₘ indicates in each case the possible number of carbon atoms in the group.

The term “substituted with”, e.g. as used in “partially, or fully substituted with” means that one or more, e.g. 1, 2, 3, 4 or 5 or all of the hydrogen atoms of a given radical have been replaced by one or more, same or different substituents. Accordingly, for substituted cyclic moieties, e.g. 1-cyanocyclopropyl, one or more of the hydrogen atoms of the cyclic moiety may be replaced by one or more, same or different substituents.

The term “C₈-C₂₀-alkyl”, respectively “C₁₀-C₁₆-alkyl”, as used herein refers to a branched or linear, meaning unbranched, saturated hydrocarbon group having. 8 to 20 carbon atoms, preferably 10 to 16 carbon atoms, for example octyl, 2-ethylhexyl,2-propylheptyl, nonyl, isononyl, decyl, dodecyl, 7-ethyl-2-methyl-4-undecyl, tridecyl, tetradecyl, hexadecyl, 2-hexyl-1-decyl, octadecyl, and their isomers.

The term “C₈-C₂₀-alkenyl”, respectively “C₁₀-C₁₆-alkenyl”, as used herein intends a branched or linear, meaning unbranched, unsaturated hydrocarbon group having 8 to 20 carbon atoms, preferably 10 to 16 carbon atoms, and a double bond in any position, such as decenyl, 1-decen-3-yl, 9-decenyl, 5-hexadecnyl, and their isomers.

The term “C₈-C₂₀-alkynyl”, respectively “C₁₀-C₁₆-alkynyl”, as used herein refers to a branched or linear, meaning unbranched, unsaturated hydrocarbon group having 8 to 20 carbon atoms, preferably 10 to 16 carbon atoms and containing at least one triple bond, such as decyne, 1-decyne and the like.

Similarly, “C₁-C₁₀-alkoxy” refers to linear, meaning unbranched or straight-chain, or branched alkyl groups having 1 to 10, in particular 1 to 6 or 1 to 4 carbon atoms (as mentioned above) bonded through oxygen at any bond in the alkyl group. Examples include C₁-C₄-alkoxy such as methoxy, ethoxy, propoxy, isopropoxy, butoxy, sec-butoxy, isobutoxy and tert-butoxy.

The terms “heterocycle”, “heterocyclyl” or “heterocyclic ring” includes, unless otherwise indicated, in general 5- or 6-membered, in particular 6-membered monocyclic heterocyclic radicals. The heterocyclic radicals may be saturated, partially unsaturated, or fully unsaturated. As used in this context, the term “fully unsaturated” may also include “aromatic”. In a preferred embodiment, a fully unsaturated heterocycle is thus an aromatic heterocycle, preferably a 5- or 6-membered aromatic heterocycle comprising one or two heteroatoms selected from O and S as ring members. Examples of aromatic heterocycles are e.g. 5- or 6-membered heteroaromatic radicals which include pyridyl, i.e. 2-, 3-, or 4-pyridyl, pyrimidinyl, i.e. 2-, 4- or 5-pyrimidinyl, pyrazinyl, pyridazinyl, i.e. 3- or 4-pyridazinyl, thienyl, i.e. 2- or 3-thienyl, furyl, i.e. 2- or 3-furyl, pyrrolyl, i.e. 2- or 3-pyrrolyl, oxazolyl, i.e. 2-, 3- or 5-oxazolyl, isoxazolyl, i.e. 3-, 4- or 5-isoxazolyl, thiazolyl, i.e. 2-, 3- or 5-thiazolyl, isothiazolyl, i.e. 3-, 4- or 5-isothiazolyl, pyrazolyl, i.e. 1-, 3-, 4- or 5-pyrazolyl, i.e. 1-, 2-, 4- or 5-imidazolyl, oxadiazolyl, e.g. 2- or 5-[1,3,4]oxadiazolyl, 4- or 5-(1,2,3-oxadiazol)yl, 3- or 5-(1,2,4-oxadiazol)yl, 2- or 5-(1,3,4-thiadiazol)yl, thiadiazolyl, e.g. 2- or 5-(1,3,4-thiadiazol)yl, 4- or 5-(1,2,3-thiadiazol)yl, 3- or 5-(1,2,4-thiadiazol)yl, triazolyl, e.g. 1H-, 2H- or 3H-1,2,3-triazol-4-yl, 2H-triazol-3-yl, 1H-, 2H-, or 4H-1,2,4-triazolyl and tetrazolyl, i.e. 1H- or 2H-tetrazolyl. Unless otherwise indicated, “hetaryls” are thus covered by the term “heterocycles”. Regrading heterocyclic non-aromatic radicals, optionally present S-atoms as ring members may be non-oxidized as S or oxidized as SO or SO₂. Examples of 5- or 6-membered heterocyclic radicals comprise saturated or unsaturated, non-aromatic heterocyclic rings, such as oxiranyl, oxetanyl, thietanyl, thietanyl-S-oxid (S-oxothietanyl), thietanyl-S-dioxid (S-dioxothiethanyl), pyrrolidinyl, pyrrolinyl, pyrazolinyl, tetrahydrofuranyl, dihydrofuranyl, 1,3-dioxolanyl, thiolanyl, S-oxothiolanyl, S-dioxothiolanyl, dihydrothienyl, S-oxodihydrothienyl, S-dioxodihydrothienyl, oxazolidinyl, oxazolinyl, thiazolinyl, oxathiolanyl, piperidinyl, piperazinyl, pyranyl, dihydropyranyl, tetrahydropyranyl, 1,3- and 1,4-dioxanyl, thiopyranyl, S.oxothiopyranyl, S-dioxothiopyranyl, dihydrothiopyranyl, S-oxodihydrothiopyranyl, S-dioxodihydrothiopyranyl, tetrahydrothiopyranyl, Soxotetrahydrothiopyranyl, S-dioxotetrahydrothiopyranyl, morpholinyl, thiomorpholinyl, S-oxothiomorpholinyl, S-dioxothiomorpholinyl, thiazinyl and the like.

The term “ammonium” per se refers to the cation NH₄⁺. The expression “ammonium cations of primary, secondary or tertiary amines”, as used similarly in the expression “primary, secondary, tertiary amines, and ammonium salts thereof” refers to protonated primary, secondary or tertiary amines. The protonation of such ammonium cations is dependent on the pH and the positive charge varies accordingly.

With respect to the components A.1 and A.2 of the microemulsion, the terms “agriculturally active”, “agriculturally active compound”, “pesticidally active”, “pesticidally active compound”, and “pesticide” are used synonymously.

As essential components the liquid agrochemical microemulsion composition of the present invention contains
at least one organosulfate compound of formula (I)

[R-(A)ₓ-OSO₃⁻]-M⁺ (I);
wherein
R is linear C₁₀-C₁₆-alkyl, C₁₀-C₁₆-alkenyl, or C₁₀-C₁₆-alkynyl;
A is a group of the following formula (i)

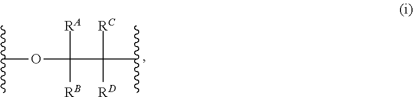

wherein
the oxygen atom is bound to R in formula (I); and
R^{A}, R^{B}, R^{C}, and R^{D} are selected from hydrogen, CH₃, or CH₂CH₃ with the proviso, that the sum of C-atoms of R^{A}, R^{B}, R^{C}, and R^{D} is 0, 1 or 2;
M⁺ is a monovalent cation selected from alkali metal ions such as sodium or potassium, ammonium or a ammonium salts of a primary, secondary, or tertiary amine having a molecular weight of from 32 to 180 g/mol, or a mixture thereof; and x is a number selected from 1 to 10.
   and
at least one organosulfate compound of formula (II)

[R^{a}-(A)_{y}-OSO₃⁻]-M⁺ (II);
wherein
R^{a} is a branched C₈-C₂₀-alkyl, C₈-C₂₀-alkenyl, or C₈-C₂₀-alkynyl;
A is a group of the following formula (i)

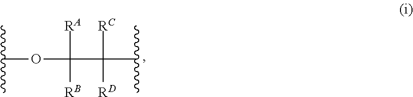

wherein
the oxygen atom is bound to R^{a} in formula (II); and
R^{A}, R^{B}, R^{C}, and R^{D} are selected from hydrogen, CH₃, or CH₂CH₃ with the proviso, that the sum of C-atoms of R^{A}, R^{B}, R^{C}, and R^{D} is 0, 1 or 2;
M⁺ is a monovalent cation selected from alkali metal ions such as sodium or potassium, ammonium or a ammonium salts of a primary, secondary, or tertiary amine having a molecular weight of from 32 to 180 g/mol, or a mixture thereof and
y is 0 or a number selected from 1 to 10.

### Preparation Methods

Compounds of formula (I) and (II) can be prepared by standard methods of organic chemistry. The respective anionic moiety R-(A)ₓ-OSO₃⁻ (I-a) or R^{a}-(A)_{y}-OSO₃⁻ (II-a) is commercially available in the form of sodium or potassium salts, e.g. under the tradename Genapol LRO from Clariant, and can be prepared as described in U.S. Ser. No. 10/091,994B2, columns 1-2, which is incorporated herein by reference. Compounds of formula (I) or (II) are ionic compounds that comprise the anionic moiety (I-a) or (II-a) and the monovalent cation M+, which is positively and singly charged.

The compounds of formula (I) or (II) may contain an alkali metal ion, such as sodium or potassium as the monovalent cation M⁺, or an ammonium cation, such as NH₄⁺, or a primary, secondary, or tertiary amine, i.e. a protonated primary, secondary or tertiary amine, or a quaternary ammonium cation. Such compounds are available from the commercially available sodium or potassium salts by ion exchange chromatography or other methods suitable for ion exchange. Alternatively, compounds of formula (I), wherein M⁺ is NH₄⁺ or an ammonium cation of a primary, secondary, or tertiary amine, are available by reaction of compounds of formula (I) or (II) with SO₃ or ClSO₃H and subsequent addition of the respective amine base or ammonia M as depicted in Scheme 1

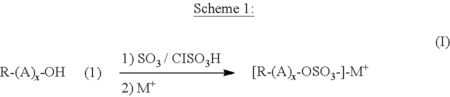

wherein all variables have a meaning as defined for formula (I).

Analogously, compounds of formula (II), wherein M⁺ is NH₄⁺ or an ammonium cation of a primary, secondary, or tertiary amine, can be prepared as shown in Scheme 1, with R being R^{a} instead for R^{a}-(A)_{y}-OH (compound of formula 1a).

Reactions of this type are typically carried out at temperatures of 50 to 100° C. under addition of an excess of SO₃ or ClSO₃H compared to the amount of compound of formula (I), compound of formula (II) respectively. Compounds of formula (1) and (1a) are commercially available under various tradenames, e.g. the Lutensol TO series from BASF, and may be produced from the respective alcohols R—OH by alkoxylation with ethylene oxide, propylene oxide, or butylene oxide as described in U.S. Ser. No. 10/091,994B2.

### EMBODIMENTS OF THE INVENTION

The variables of formula (I):

[R-(A)ₓ-OSO₃⁻]-M⁺ (I),

and of formula (II):

[R^{a}-(A)_{y}-OSO₃—]-M⁺(II)

have the following individual and/or preferred meanings and embodiments.

Combinations of such preferred meanings and embodiments of all levels of preference are within the scope of the invention.

Amine bases for M⁺ are equally commercially available and form the respective ammonium cations M⁺ of primary, secondary, or tertiary amines in compounds of formula (I) or (II).

The monovalent cation M⁺ is thus typically selected from
alkali metal cations, e.g. Na⁺, and K⁺;
ammonium cation NH₄⁺;
ammonium cations of a primary, secondary, and tertiary amines; and
quaternary ammonium cations.

In one group of embodiments, the monovalent cation M⁺ is an alkali metal cation or NH₄⁺.

In particular, the monovalent cation M⁺ is an alkali metal cation, preferably Na⁺ or K⁺, more preferably Na⁺.

In another group of embodiments the molecular weight of the monovalent ammonium cation M+ is from 32 to 180 g/mol

In a preferred group of embodiments, the monovalent cation M+ ammonium cation of a primary, secondary, or tertiary amine has a molecular weight of from 55 to 180 g/mol.

In another preferred group of embodiments, the monovalent ammonium cation M⁺ contains exactly one nitrogen atom per molecule.

In particular, the ammonium cation M⁺ is of formula (ii)

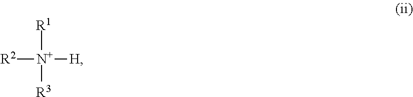

wherein
R¹, R² and R³ are selected from hydrogen or C₁-C₁₀-alkyl, which is unsubstituted or substituted with OH, C₁-C₁₀-alkoxy or hydroxy-C₁-C₁₀-alkoxy, with the proviso that at least one substituent R¹, R², or R³ is not hydrogen;

or wherein
two of the substituents R¹, R², or R³ form together with the N-atom to which they are bound, a 5-, or 6-membered, saturated, partially- or fully unsaturated heterocycle containing optionally and additionally independently from one another one or two atoms oxygen and/or sulfur, and wherein said S-atom(s) are independently oxidized or non-oxidized.

R in formula (I) is a C₁₀-C₁₆-alkyl, C₁₀-C₁₆-alkenyl, or C₁₀-C₁₆-alkenyl radical.

R^{a} in formula (II) is a C₈-C₂₀-alkyl, C₈-C₂₀-alkenyl, or C₈-C₂₀-alkenyl radical. Typically, R^{a} is C₈-C₁₆-alkyl, preferably C₈-C₁₂-alkyl, more preferably C₈-C₁₀-alkyl, and in particular C₈-alkyl.

In another embodiment, R^{a} is C₈-C₁₆-alkenyl, preferably C₈-C₁₂-alkenyl, more preferably C₈-C₁₀-alkenyl, and in particular C₈-alkenyl.

In another embodiment, R^{a} is C₈-C₁₆-alkynyl, preferably C₈-C₁₂-alkynyl, more preferably C₈-C₁₀-alkynyl, and in particular C₈-alkynyl.

The groups A in formula (I) and in formula (II) are selected independently from one another, as well as independently within the organosulfate compounds of formula (I) or formula (II)

Hence, each individual A, regardless whether in formula (I) and formula (II), is independently from another a group (i)

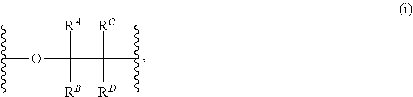

wherein
the oxygen atom in formula (i) is bound to R in formula (I) or respectively R^{a} in formula (II); and

R^{A}, R^{B}, R^{C}, and R^{D} are selected from H, CH₃, or CH₂CH₃ with the proviso that the sum of C-atoms of R^{A}, R^{B}, R^{C}, and R^{D} is 0, 1 or 2.

Preferably, the sum of C-atoms of R^{A}, R^{B}, R^{C}, and R^{D} is 0 or 1.

More preferably, R^{A}, R^{B}, R^{C} and R^{D} are all H.

Although each group A (meaning each A in formula (I) and each A in formula (II)) is independent from one another, in one preferred embodiment groups of A are all the same, preferably wherein R^{A}, R^{B}, R^{C} and R^{D} are H.

In one embodiment, a mixture of different groups A is present, such as a mixture of groups A, wherein all substituents R^{A}, R^{B}, R^{C} and R^{D} are H, with groups A, wherein one substituent R^{A}R^{B}, R^{C} or R^{D} is CH₃.

In another embodiment, a mixture of different groups A is present, such as a mixture of groups A, wherein all substituents R^{A}, R^{B}, R^{C} and R^{D} are H, with groups A, wherein one substituent R^{A}, R^{B}, R^{C} or R^{D} is CH₂CH₃.

In case a mixture of different groups A is present, the molar ratio of groups A, wherein all substituents R^{A}, R^{B}, R^{C} and R^{D} are H, is typically at least 10 mol %, preferably at least 25 mol %, more preferably at least 50 mol %, and in particular at least 80 mol %.

The indexes x and y are selected independently from one another.

The index x is from 1 to 10. The index x represents a molar mean of all molecules of compounds of formula (I) in a given ensemble and is any number from 1 to 10, including real numbers between 1 and 10. The skilled person is aware that the common synthesis of compounds of formula (I) includes an alkoxylation step of alcohol R—OH, as outlined above, which alkoxylation step results in a statistical distribution of species R-(A)ₓ-OH, and in turn results in a statistical distribution of compounds of formula (I) regarding the index x.

Typically, the index x is up to 8, preferably up to 6, more preferably up to 4, most preferably up to 3. The index x may be at least 1.5, preferably at least 2. The index x is typically from 1 to 5, preferably from 1 to 4, more preferably from 1 to 3, most preferably from 1.5 to 3, and in particular from 1.5 to 2.5.

The index y is 0 or a number from 1 to 10. The index y represents a molar mean of all molecules of compounds of formula (II) in a given ensemble and is any number from 1 to 10, including real numbers between 1 and 10. The skilled person is aware that the common synthesis of compounds of formula (II) includes an alkoxylation step of alcohol R^{a}—OH, as outlined above, which alkoxylation step results in a statistical distribution of species R^{a}-(A)_{y}-OH, and in turn results in a statistical distribution of compounds of formula (I) regarding the index y.

Typically, the index y is up to 8, preferably up to 6, more preferably up to 4, most preferably up to 3. The index y may be preferably 0. The index y is typically from 0 to 5, preferably from 0 to 4, more preferably from 0 to 3, most preferably from 0 to 2, and in particular from 0.

In one group of embodiments, the substituents of formula (I) have the following meaning:

R is C₁₀-C₁₆-alkyl;
each A is independently a group

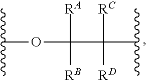

wherein
R^{A}, R^{B}, R^{C}, and R^{D} are H, CH₃, or CH₂CH₃ with the proviso that the sum of C-atoms of R^{A}, R^{B}, R^{C}, and R^{D} is 0, 1 or 2;
M⁺ is a monovalent cation selected from the group of alkali metal cations, NH₄⁺, ammonium cations of primary, secondary, and tertiary amines and quaternary ammonium cations having a molecular weight of from 55 to 180 g/mol; and any mixture thereof; and
the index x is a number from 1 to 5.

In preferred groups of embodiments, the substituents of formula (I) have the following meaning:
R is C₁₀-C₁₆-alkyl;
each A is a group

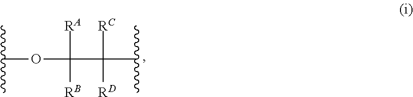

wherein
R^{A}, R^{B}, R^{C}, and R^{D} are H;
M⁺ is a monovalent cation selected from the group of alkali metal cations, NH₄⁺, ammonium cations of primary, secondary, and tertiary amines and quaternary ammonium cations having a molecular weight of from 55 to 180 g/mol; and any mixture thereof; and
   the index x is a number from 1 to 5.

In particularly preferred groups of embodiments, the substituents of formula (I) have the following meaning:

### R is C₁₀₋₁₆alkyl;

each A is a group

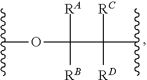

wherein
R^{A}, R^{B}, R^{C}, and R^{D} are H;
the index x is a number from 1 to 3; and
M⁺ is a monovalent cation selected from Na⁺, and K⁺.

In especially preferred groups of embodiments, the substituents of formula (I) have the following meaning:
R is C₀₋₁₆alkyl;
each A is a group

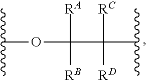

wherein
R^{A}, R^{B}, R^{C}, and R^{D} are H;
the index x is a number from 1 to 3; and
M⁺ is Na⁺.

In one group of embodiments, the substituents of formula (II) have the following meaning:
R^{a} is C₃-C₁₆-alkyl;
each A is independently a group

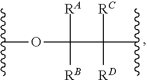

wherein
R^{A}, R^{B}, R^{C}, and R^{D} are H, CH₃, or CH₂CH₃ with the proviso that the sum of C-atoms of R^{A}, R^{B}, R^{C}, and R^{D} is 0, 1 or 2;
M⁺ is a monovalent cation selected from the group of alkali metal cations, NH₄⁺, ammonium cations of primary, secondary, and tertiary amines and quaternary ammonium cations having a molecular weight of from 55 to 180 g/mol; and any mixture thereof; and
the index y is a number from 0 to 5.

In preferred groups of embodiments, the substituents of formula (II) have the following meaning:
R is C₈-C₁₂-alkyl;
each A is a group

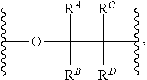

wherein
R^{A}, R^{B}, R^{C}, and R^{D} are H;
M⁺ is a monovalent cation selected from the group of alkali metal cations, NH₄*, ammonium cations of primary, secondary, and tertiary amines and quaternary ammonium cations having a molecular weight of from 55 to 180 g/mol; and any mixture thereof; and
the index y is a number from 0 to 5.

In particularly preferred groups of embodiments, the substituents of formula (II) have the following meaning:
R^{a} is C₃-C₁₀-alkyl;
each A is a group

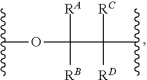

wherein
R^{A}, R^{B}, R^{C}, and R^{D} are H;
M⁺ is a monovalent cation selected from the group of alkali metal cations, NH4+, ammonium cations of primary, secondary, and tertiary amines and quaternary ammonium cations having a molecular weight of from 55 to 180 g/mol; and any mixture thereof; and
the index y is a number from 0 to 5.

In an especially preferred group of embodiments, the substituents of formula (I) have the following meaning:
R^{a} is C₃-alkyl;
each A is a group

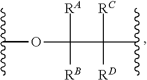

wherein
R^{A}, R^{B}, R^{C}, and R^{D} are H;
M⁺ is a monovalent cation selected from the group of alkali metal cations, NH₄⁺, ammonium cations of primary, secondary, and tertiary amines and quaternary ammonium cations having a molecular weight of from 55 to 180 g/mol; and any mixture thereof; and
the index y is a number from 0 to 5.

In a likewise especially preferred group of embodiments, the substituents of formula (II) have the following meaning:
R^{a} is C₈-alkyl;
each A is a group

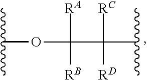

wherein
R^{A}, R^{B}, R^{C}, and R^{D} are H;
M⁺ is a monovalent cation selected from the group of alkali metal cations, NH₄⁺, ammonium cations of primary, secondary, and tertiary amines and quaternary ammonium cations having a molecular weight of from 55 to 180 g/mol; and any mixture thereof; and
the index y is a number from 0 to 3.

In a very especially preferred group of embodiments, the substituents of formula (II) have the following meaning:
R^{a} is C₈-alkyl;
each A is a group

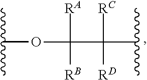

wherein
R^{A}, R^{B}, R^{C}, and R^{D} are H;
the index y is 0; and
M⁺ is a monovalent cation selected from Na⁺, and K⁺.

The agrochemical microemulsions of the invention generally comprise the compound(s) of formula (I) in a concentration of at least 1 wt %, preferably at least 5 wt % more preferably at least 10 wt %, most preferably at least 15 wt %, in particular at least 20 wt %, and especially at least 30 wt %, such as at least 40 wt % based on the total weight of the agrochemical microemulsion. The agrochemical microemulsions of the invention generally comprise the compound(s) of formula (I) in a concentration of up to 90 wt %, preferably up to 70 wt %, more preferably up to 50 wt % based on the total weight of the agrochemical microemulsion. The agrochemical microemulsions of the invention frequently comprise the compound(s) of formula (I) in a concentration of from 5 to 60 wt %, more preferably 10 to 50 wt %, most preferably 15 to 40 wt % based on the total weight of the agrochemical microemulsion.

The agrochemical microemulsions of the invention generally comprise the compound(s) of formula (II) in a concentration of at least 1 wt %, preferably at least 5 wt % more preferably at least 10 wt %, most preferably at least 15 wt %, in particular at least 20 wt %, and especially at least 30 wt %, such as at least 40 wt % based on the total weight of the agrochemical microemulsion. The agrochemical microemulsions of the invention generally comprise the compound(s) of formula (II) in a concentration of up to 90 wt %, preferably up to 70 wt %, more preferably up to 50 wt % based on the total weight of the agrochemical microemulsion. The agrochemical microemulsions of the invention frequently comprise the compound(s) of formula (II) in a concentration of from 5 to 60 wt %, more preferably 10 to 50 wt %, most preferably 15 to 40 wt % based on the total weight of the agrochemical microemulsion.

The agrochemical microemulsions of the invention generally comprise the compound(s) of formula (I) and the compound(s) of formula (II) together in a concentration of at least 5 wt % more preferably at least 10 wt %, most preferably at least 15 wt %, in particular at least 20 wt %, and especially at least 30 wt %, such as at least 40 wt % based on the total weight of the agrochemical microemulsion. The agrochemical microemulsions of the invention generally comprise the compound(s) of formula (I) and the compound(s) of formula (II) together in a concentration of up to 70 wt %, more preferably up to 50 wt % based on the total weight of the agrochemical microemulsion. The agrochemical microemulsions of the invention frequently comprise the compound(s) of formula (I) and the compound(s) of formula (II) together in a concentration of from 5 to 70 wt %, preferably 5 to 60 wt %, more preferably 10 to 50 wt %, most preferably 15 to 40 wt % based on the total weight of the herbicidal composition.

The molecular weight of the primary, secondary or tertiary amine, of the ammonium cation in the ammonium salt or the quaternary ammonium cation in the quaternary ammonium salt, is from 32 to 200 g/mol. In one embodiment, the molecular weight of the primary, secondary or tertiary amine, of the ammonium cation in the ammonium salt or the quaternary ammonium cation in the quaternary ammonium salt, is from is at least 35 g/mol. In another embodiment, the molecular weight of the primary, secondary or tertiary amine, of the ammonium cation in the ammonium salt or the quaternary ammonium cation in the quaternary ammonium salt, is at least 40 g/mol. In another embodiment, the molecular weight of the primary, secondary or tertiary amine, of the ammonium cation in the ammonium salt or the quaternary ammonium cation in the quaternary ammonium salt, is at least 45 g/mol. In another embodiment, the molecular weight of the primary, secondary or tertiary amine, of the ammonium cation in the ammonium salt or the quaternary ammonium cation in the quaternary ammonium salt, is at least 50 g/mol. In another embodiment, the molecular weight of the primary, secondary or tertiary amine, of the ammonium cation in the ammonium salt or the quaternary ammonium cation in the quaternary ammonium salt is at least 55 g/mol. In another embodiment, the molecular weight of the primary, secondary or tertiary amine, of the ammonium cation in the ammonium salt or the quaternary ammonium cation in the quaternary ammonium salt, is at least 60 g/mol. In another embodiment, the molecular weight of the primary, secondary or tertiary amine, of the ammonium cation in the ammonium salt or the quaternary ammonium cation in the quaternary ammonium salt in the ammonium salt, is at least 61 g/mol. In one embodiment, the molecular weight of the primary, secondary or tertiary amine, of the ammonium cation in the ammonium salt or the quaternary ammonium cation in the quaternary ammonium salt, is up to 195 g/mol. In another embodiment, the molecular weight of the primary, secondary or tertiary amine, of the ammonium cation in the ammonium salt or the quaternary ammonium cation in the quaternary ammonium salt, is up to 190 g/mol g/mol. In another embodiment, the molecular weight of the primary, secondary or tertiary amine, of the ammonium cation in the ammonium salt or the quaternary ammonium cation in the quaternary ammonium salt, is up to 185 g/mol. In another embodiment, the molecular weight of the primary, secondary or tertiary amine, of the ammonium cation in the ammonium salt or the quaternary ammonium cation in the quaternary ammonium salt, is up to 180 g/mol. In another embodiment, the molecular weight of the primary, secondary or tertiary amine, of the ammonium cation in the ammonium salt or the quaternary ammonium cation in the quaternary ammonium salt, is up to 175 g/mol. In another embodiment, the molecular weight of the primary, secondary or tertiary amine, of the ammonium cation in the ammonium salt or the quaternary ammonium cation in the quaternary ammonium salt, is up to 170 g/mol. In another embodiment, the molecular weight of the primary, secondary or tertiary amine, of the ammonium cation in the ammonium salt or the quaternary ammonium cation in the quaternary ammonium salt, is up to 160 g/mol. In another embodiment, the molecular weight of the primary, secondary or tertiary amine, of the ammonium cation in the ammonium salt or the quaternary ammonium cation in the quaternary ammonium salt, is up to 150 g/mol. In another embodiment, the molecular weight of the primary, secondary or tertiary amine, of the ammonium cation in the ammonium salt or the quaternary ammonium cation in the quaternary ammonium salt, is up to 140 g/mol. In another embodiment, the molecular weight of the primary, secondary or tertiary amine, of the ammonium cation in the ammonium salt or the quaternary ammonium cation in the quaternary ammonium salt, is up to 130 g/mol. In another embodiment, the molecular weight of the primary, secondary or tertiary amine, of the ammonium cation in the ammonium salt or the quaternary ammonium cation in the quaternary ammonium salt, is up to 120 g/mol. In another embodiment, the molecular weight of the primary, secondary or tertiary amine, of the ammonium cation in the ammonium salt or the quaternary ammonium cation in the quaternary ammonium salt is up to 110 g/mol. In another embodiment, the molecular weight of the primary, secondary or tertiary amine, of the ammonium cation in the ammonium salt or the quaternary ammonium cation in the quaternary ammonium salt is up to 105 g/mol. In one embodiment, the molecular weight of the primary, secondary or tertiary amine, of the ammonium cation in the ammonium salt or the quaternary ammonium cation in the quaternary ammonium salt is from 35 g/mol to 150 g/mol. In another embodiment, the molecular weight of the primary, secondary or tertiary amine, of the ammonium cation in the ammonium salt or the quaternary ammonium cation in the quaternary ammonium salt is from 40 g/mol to 140 g/mol. In another embodiment, the molecular weight of the primary, secondary or tertiary amine, of the ammonium cation in the ammonium salt or the quaternary ammonium cation in the quaternary ammonium salt is from 55 g/mol to 180 g/mol. In another embodiment, the molecular weight of the primary, secondary or tertiary amine, of the ammonium cation in the ammonium salt or the quaternary ammonium cation in the quaternary ammonium salt is from 50 g/mol to 120 g/mol. In one embodiment, the molecular weight of the primary, secondary or tertiary amine, of the ammonium cation in the ammonium salt or the quaternary ammonium cation in the quaternary ammonium salt is from 55 g/mol to 110 g/mol. In one embodiment, the molecular weight of the primary, secondary or tertiary amine, of the ammonium cation in the ammonium salt or the quaternary ammonium cation in the quaternary ammonium salt is from 60 g/mol to 110 g/mol.

The primary, secondary or tertiary amine N and the protonated ammonium form N⁺ form a conjugated acid/base pair and are in equilibrium in aqueous conditions as displayed in Scheme a:

N⁺+H₂O⇄N+H₃O⁺ Scheme a:

The invention thus also pertains to a situation wherein the amine is present both in its protonated state N⁺ and in its non-protonated state N.

The molar ratio of protonated amine N⁺ to non-protonated amine N is typically at least 1:1, preferably at least 3:1, more preferably at least 5:1 most preferably at least 10:1. The molar ratio of protonated amine N⁺ to non-protonated amine N is typically up to 50:1, preferably up to 20:1, more preferably up to 15:1 most preferably up to 8:1.

The ratio is dependent of the pH of the liquid herbicidal composition. The pH is typically from 5 to 12, preferably from 6 to 10, more preferably from 6.5 to 9. The pH may be adjusted by the addition of an acid, such as HCl, H₂SO₄, H₂SO₃, or methylsulfonic acid. By addition of an acid, the amine N is protonated and present in the form of its ammonium salt, such as the chloride salt, the sulfate salt, the sulfonate salt, or the methyl sulfonate salt. Thus, the ammonium salt of the primary, secondary or tertiary amine is formed in situ by reaction of the acid with the amine N. Alternatively, the respective ammonium salt of the primary, secondary or tertiary amine may be added to the composition.

Since compounds of formula (I) are ionic compounds, and since the amine component may contain, or form an ammonium salt, or contain a quaternary ammonium salt, the compounds of formula (I) and the amine component may exchange their respective counterions in solution as displayed in Scheme 2

[R-(A)ₓ-OSO₃—]—M⁺(I)+[B⁻]-[Q⁺]⇄[R-(A)ₓ-OSO₃—]-Q⁺(I-b)+[B⁻][M⁺] Scheme 2:

wherein B⁻ is a monovalent anion, such as Cl⁻, SO₄⁻, SO₃⁻, or CH₃SO₃⁻, wherein Q⁺ is an ammonium cation of the primary, secondary, or tertiary amine, or a quaternary ammonium cation of the quaternary ammonium salt, and wherein all other variables have a meaning as defined for formula (I). Ion exchange reactions of this type usually occur in liquid compositions and reach an equilibrium in which both the reaction yielding compounds of formula (I-b) and the backward reaction to compounds of formula (I) are in equilibrium. Thus, the invention also pertains to a situation in which the agrochemical composition contains compounds of formula (I) and compounds of formula (I-b) in any given ratio. For example, the molar ratio of compounds of formula (I) to compounds of formula (I-b) may be from 100:1 to 1:100, preferably from 10:1 to 1:10.

Accordingly, the agrochemical composition may contain a mixture of cations, including monovalent cations M⁺ and the cations of the ammonium salt(s) of primary, secondary, and tertiary amine(s) and of the quaternary ammonium salts Q⁺. The invention thus also pertains to a situation in which the molar ratio of the monovalent cations M⁺ compared to the cations Q⁺ as defined above is at least 1:100, preferably at least 1:10, more preferably at least 1:1, most preferably at least 2:1, and in particular at least 10:1, such as at least 50:1. The molar ratio of cations M⁺ to cations Q⁺ may be from 100:1 to 1:100, preferably from 20:1 to 1:20.

The invention also pertains to a situation in which the molar concentration of the monovalent cations M⁺ compared to the total amount of the moiety (I-a) in the composition, either in the form of compound of formula (I), as compound of formula (I-b) or as a different salt, is less than 100 mol-%. The molar concentration of the monovalent cation M⁺ compared to the total amount of the moiety (I-a) is typically at least 10 mol %, preferably at least 20 mol-%, more preferably at least 30 mol-%, most preferably at least 50 mol-%, and in particular at least 80 mol-%, such as at least 90 mol-%. Preferably the molar concentration of the monovalent cations M⁺ compared to the total amount of the moiety (I-a) is at least 99 mol-%, in particular 100 mol-%.

The purpose of the microemulsion formulation according to the present invention is to accomplish the combination of a water-soluble pesticide (A.1), hereinafter also termed water-soluble agrochemical active, especially in form of a salt, with a water insoluble or sparingly watersoluble pesticide (A.2) as active ingredients.

Preferably, the water-soluble pesticide (A.1) contained in the microemulsion according to the present invention is a water-soluble herbicide. The water-soluble pesticide (A.1), in particular a salt thereof, has in particular a solubility in water of more than 10 g/l, preferably at least or more than 50 g/l, especially at least 100 g/l. The solubility of the pesticide compounds (A.1) and (A.2) as referred to herein is the solubility of the respective pesticide compound in deionized water at 25° C. and 1 bar.

More preferably the water-soluble agrochemical active to be used in the microemulsion according to the present invention is a water-soluble herbicide (A.1) which is selected from the group consisting of glufosinate or its salts, dicamba or its salts, glyphosate or its salts and imidazolinone herbicides or their salts or any derivatives of the imidazolinone herbicides or their salts.

In a preferred embodiment the actives and/or active salts which are suitable to be formulated in aqueous phase of the microemulsion according to the present invention are glufosinate salts, in particular glufosinate ammonium, and especially the L-enantiomer salts, such as L-Glufosinate-ammonium.

Suitable salts of glyphosate are for example glyphosate-ammonium, glyphosate-diammonium, glyphosate-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).

In the case of dicamba, suitable salts include those, where the counterion is an agriculturally acceptable cation. For example, suitable salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of a suitable ester are dicamba-methyl and dicamba-butotyl.

Suitable imidazolinone herbicides are imazapic or its salts, imazamox or its salts, imazapyr or salts, imazaquin or its salts and imazathapyr or salts.

A suitable salt of imazamox is for example imazamox-ammonium.

Suitable salts of imazapic are for example imazapic-ammonium and imazapic-isopropylammonium.

Suitable salts of imazapyr are for example imazapyr-ammonium and imazapyr-isopropylammonium.

A suitable salt of imazaquin is for example imazaquin-ammonium.

Suitable salts of imazethapyr are for example imazethapyr-ammonium and imazethapyr-isopropylammonium.

As mentioned above, most preferably the water-soluble agrochemical active to be used in the microemulsion according to the present invention is glufonsinate, especially a water soluble glufosinate salt.

Glufosinate (CAS Reg. No. 51276-47-2), with IUPAC-Name (2RS)-2-amino-4-[hydroxy(methyl)phosphinoyl]butyric acid, or 4-[hydroxy(methyl)phosphinoyl]-DL-homoalanine) or DL-4-[hydroxyl(methyl)phosphinoyl]-DL-homoalaninate, is known, as well as agronomically acceptable salts thereof, in particular glufosinate-ammonium (IUPAC-Name: ammonium (2RS)-2-amino-4-(methylphosphinato)butyric acid, CAS Reg. No. 77182-82-2). U.S. Pat. No. 4,168,963 describes phosphorus-containing compounds with herbicidal activity, of which, in particular, phosphinothricin (2-amino-4-[hydroxy(methyl)phosphinoyl]butanoic acid; common name: glufosinate) and its salts have acquired commercial importance in the agrochemistry (agricultural chemistry) sector.

For example, glufosinate and its salts—such as glufosinate ammonium—and its herbicidal activity have been described e.g. by F. Schwerdtle et al. Z. Pflanzenkr. Pflanzenschutz, 1981, Sonderheft IX, pp. 431-440.

Glufosinate as racemate and its salts are commercially available under the trade-names Basta™ and Liberty™.

Glufosinate is represented by the following structure (IV):

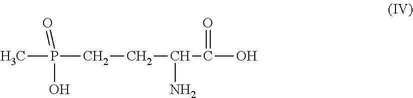

The compound of formula (IV) is a racemate.

Glufosinate is a racemate of two enantiomers, out of which only one shows sufficient herbicidal activity (see e.g. U.S. Pat. No. 4,265,654 and JP92448/83). Even though various methods to prepare L-glufosinate (and respective salts) are known, the mixtures known in the art do not point at the stereochemistry, meaning that the racemate is present (e.g. WO 2003024221, WO2011104213, WO 2016113334, WO 2009141367).

In one embodiment, the herbicidal composition comprises racemic glufosinate mixtures as described above, wherein the glufosinate comprises about 50% by weight of the L-enantiomer and about 50% by weight of the D-enantiomer. In another embodiment, the herbicidal composition comprises glufosinate, wherein at least 70% by weight of the glufosinate is L-glufosinate or a salt thereof.

L-glufosinate, with IUPAC-Name (2S)-2-amino-4-[hydroxy(methyl)phosphinoyl]butyric acid (CAS Reg. No. 35597-44-5) and also called glufosinate-P, can be obtained commercially or may be pre-pared for example as described in WO2006/104120, U.S. Pat. No. 5,530,142, EP0248357A2, EP0249188A2, EP0344683A2, EP0367145A2, EP0477902A2, EP0127429 and J. Chem. Soc. Perkin Trans. 1, 1992, 1525-1529.

Preferably, the salts of glufosinate or (L)-glufosinate are the sodium, potassium or ammonium (NH₄⁺) salts of glufosinate or L-glufosinate, in particular glufosinate-P-ammonium (IUPAC-Name: ammonium (2S)-2-amino-4-(methylphosphinato)butyric acid, CAS Reg. No. 73777-50-1), glufosinate-P-sodium (IUPAC-Name: sodium (2S)-2-amino-4-(methylphosphinato)butyric acid; CAS Reg. No. 70033-13-5) and glufosinate-P-potassium (IUPAC-Name: potassium (2S)-2-amino-4-(methylphosphinato)butyric acid) for L-glufosinate.

Hence, mixtures according to the herbicidal composition may contain (L)-glufosinate-ammonium or (L)-glufosinate-sodium or (L)-glufosinate-potassium as (L)-glufosinate salts and (L)glufosinate as free acid, preferably (L)-glufosinate. Especially preferred are herbicidal compositions, which contain (L)-glufosinate-ammonium, i.e. the ammonium (NH₄⁺) salt of glufosinate.

The term “glufosinate” as used in the present invention typically comprises, in one embodiment of the invention, about 50% by weight of the L-enantiomer and about 50% by weight of the D-enantiomer; and in another embodiment of the invention, more than 70% by weight of the L-enantiomer; preferably more than 80% by weight of the L-enantiomer; more preferably more than 90% of the L-enantiomer, most preferably more than 95% of the L-enantiomer and can be prepared as referred to above.

Preferably, the microemulsion composition comprises an agrochemically effective amount of the glufosinate or salt thereof. The term “effective amount” denotes an amount of an agrochemically active ingredient or composition, which is sufficient to achieve a biological effect, such as controlling harmful weeds on cultivated plants or in the protection of materials and which does not result in a substantial damage to the treated plants. Such an amount can vary in a broad range and is dependent on various factors, such as the pest species to be controlled, the treated cultivated plant or material, the climatic conditions and the specific agrochemical active ingredient used.

The microemulsion composition may comprise the glufosinate, or a salt thereof, in a concentration of at least 1 wt %, preferably at least 5 wt % more preferably at least 10 wt %, most preferably at least 15 wt %, in particular at least 20 wt %, and especially at least 25 wt %, such as at least 30 wt % based on the total weight of the herbicidal composition. The herbicidal agrochemical composition may comprise the glufosinate, or a salt thereof, in a concentration of up to 50 wt %, preferably up to 40 wt %, more preferably up to 30 wt % based on the total weight of the herbicidal composition. The herbicidal composition may comprise the glufosinate, or a salt thereof, in a concentration of from 5 to 50 wt %, preferably 5 to 40 wt %, more preferably 10 to 30 wt %.

Although glufosinate and/or its salts would be the preferred water-soluble agrochemical active, as mentioned above, also other water-soluble herbicides could be used in the microemulsion compositions according to the present invention.

The microemulsion composition according to the present invention is especially suitable for formulating as well water-insoluble or sparingly water soluble pesticide in agrochemical compositions. Such water-insoluble pesticidal actives (A.2) can be selected from the group of fungicides, insecticides and herbicides. The water-insoluble pesticide (A.2) has in particular a solubility in water of less than 10 g/l, preferably less than 5 g/l. The solubility as referred to herein is the solubility of the pesticide compound in deionized water at 25° C. and 1 bar. Preferably, the water insoluble or sparingly water-soluble pesticide (A.2) contained in the microemulsion according to the present invention is a water insoluble or sparingly water-soluble herbicide.

Suitable water insoluble fungicides are e.g. fungicides of the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenylcrotonates, dithiocarbamates, dithiolanes, ethylphosphonates, ethylaminothiazolecarboxamides, guanidines, hydroxy-(2-amino)pyrimi¬dines, hydroxyanilides, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenyl¬pyrroles, phenylureas, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines or triazoles.

Suitable water insoluble insecticides are, e.g. insecticides from the class of carbamates, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenone or derivatives thereof.

Suitable water insoluble herbicides are e.g. herbicides of the classes of acetamides, amides, aryloxyphenoxypropionates, benzamides, benzofuran, benzoic acids, benzothiadiazinones, bipyridylium, carba¬mates, chloroacetamides, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphoroamidates, phosphorodithioates, phthalamates, pyrazoles, pyridazino¬nes, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils or ureas.

In a preferred embodiment, the water insoluble pesticidal active ingredient is as well a herbicide.

Examples of preferred water-insoluble herbicide compounds which are suitable to be formulated in non-aqueous phase of the microemulsion of the present invention are saflufenacil, pendimethalin, atrazine, S-metolachlor, 2,4-D ester, isoxaflutole, indaziflam, diflufenzopyr, clomazone, sulfentrazone, pyroxasulam, dimethenamid-P, cinmethylin, pyroxasulfone, topramezone, mesotrione, pinoxaden, mesosulfuron, acetochlor, clethodim, propoxycarbazone, propisochlor, bentazone, clomazone, metazachlor, flumioxazin, fomesafen, aclonifen and diflufenican.

Further preferred water-insoluble pesticides (A.2) are herbicide compounds of the group of protoporphyrinogen oxidase inhibitors, also termed PPO inhibitors. In preferred groups of embodiments, the microemulsion of the invention the water-soluble pesticide (A.1) is glufosinate or a salt thereof and the water-insoluble pesticide (A.2) is a PPO inhibitor.

PPO inhibitors have typically the following chemical formula (III):

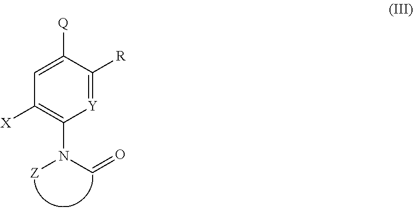

where the variables in formula (III) have the following meanings

the moiety

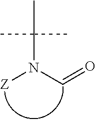

represents an N-bound heterocycle of the formula (a), (b), (c), (d), (e), (f) or (g)

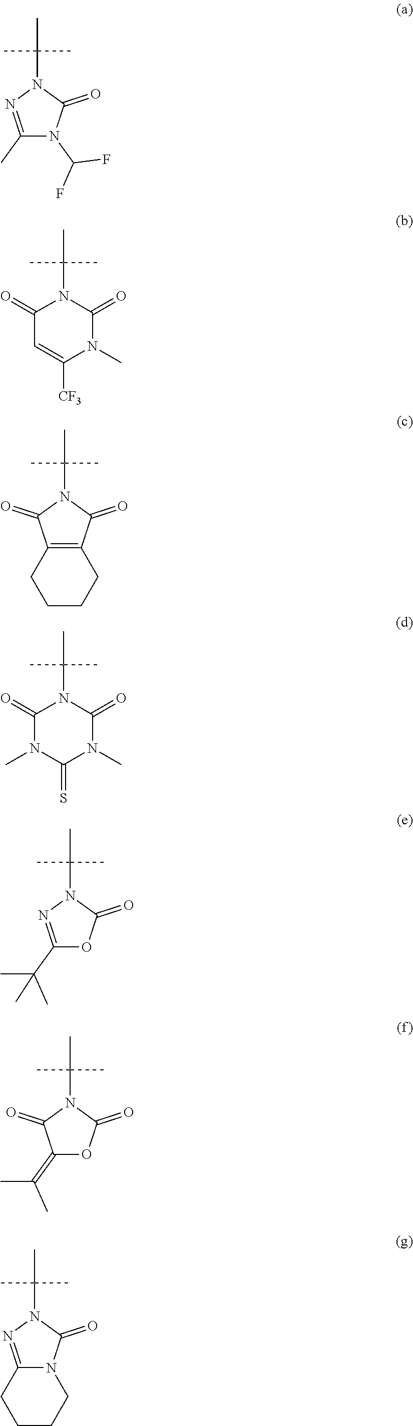

X is H, F or Cl, in particular F;

Y is N or CH;

Q is Cl

R is a radical of the following formulae (1), (2), (3), (4), (5), (6), (7), (8), (9), (10) or (11):

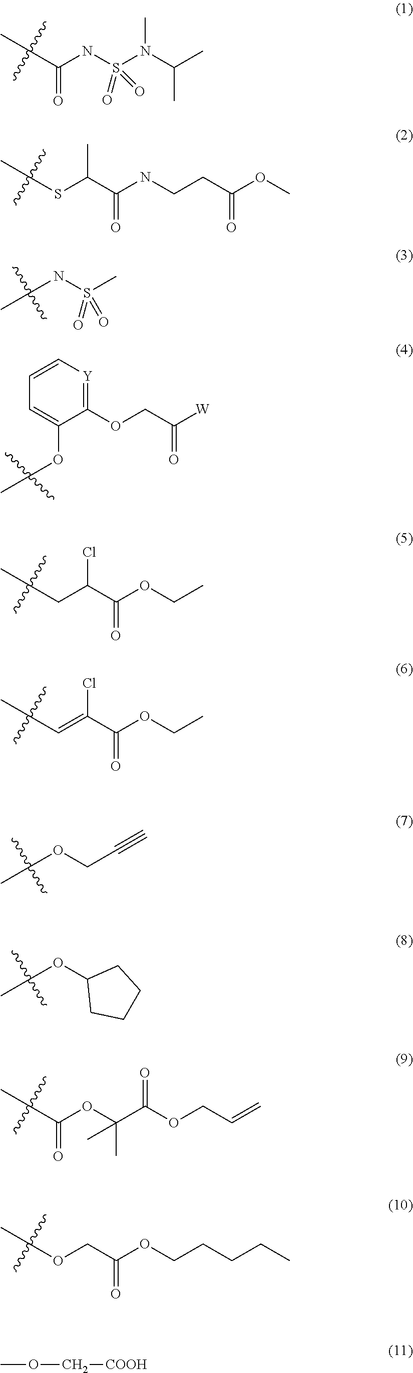

where Y in formula (4) is CH or N and W is OCH₃, OC₂H₅ or NHSO₂CH₃;

or Q and R together form one of the moieties (i), (ii)

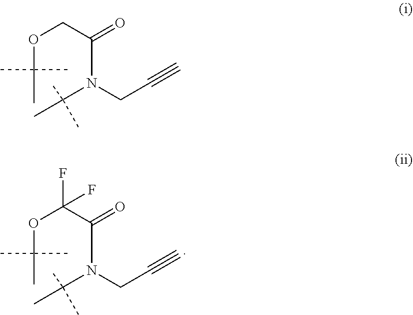

The lines crossed by a dashed line in the groups of the formulae (a) to (g), (1) to (10), (i) and (ii) indicate the points of their attachment to the remainder of the formula (III).

Examples of compounds of the formula (III) include

azafenidin, butafenacil, carfentrazone, carfentrazone-ethyl, cinidon-ethyl, flumiclorac, flumiclorac-pentyl, flumioxazin, fluthiacet, fluthiacet-methyl, oxadiargyl, oxadiazon, pentoxazone, profluazol saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0), 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy] acetic acid ethyl ester (CAS 2158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy] acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), and 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1).

A first group of particularly preferred PPO inhibitors are those of the formula (III-a)

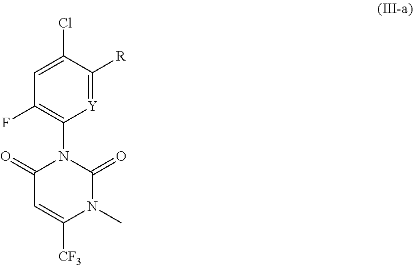

where R is a radical of the formulae (1), (2) or (4) and Y is CH or N.

Examples of compounds of the formula (III-a) include saflufenacil, tiafenacil,

ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0),

3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)pyrimidinyl]-5-fluoro-2-pyridinyl]oxy]phenoxy] acetic acid ethyl ester (CAS 2158274-50-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy] acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), and 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1).

Particular preference is given to compounds of the formula (III-a) which are selected from the group consisting of

saflufenacil, tiafenacil, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100),

2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy] acetic acid ethyl ester (CAS 2158274-50-9), 2-[[3-[[3-chloro-6-5 [3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy] acetic acid ethyl ester (CAS 2158274-56-5), and 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)acetamide (CAS 2158276-22-1).

A second group of particularly preferred PPO inhibitors are those of the formula (III-b)

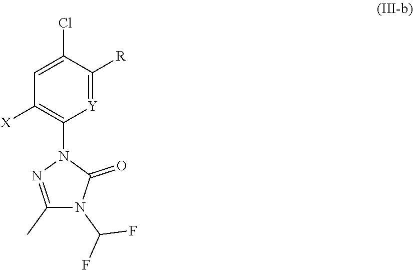

where X is F or Cl, R is a radical of the formulae (3), (4) or (5) and Y is CH or N.

Examples of compounds of the formula (III-b) include carfentrazone, carfentrazone-ethyl, sulfentrazone, methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4) with particular preference given to carfentrazone-ethyl, sulfentrazone, ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4).

A third group of particularly preferred PPO inhibitors are those of the formula (III), where

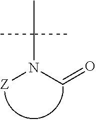

represents a radical of the formula (c), which are hereinafter referred to as compound (III-c). In compounds (III-c), X, Y, Q and R are as defined for formula (III), and X is in particular H or F, Y is in particular CH, Q is in particular Cl and R is in particular a group (6), (10) or (11) or R and Q together form a radical (i) or (ii).

Examples of compounds of the formula (III-c) include cinidon-ethyl, flumiclorac, flumicloracpentyl, flumioxazin, 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0) with particular preference given to flumioxazin.

A fourth group of particularly preferred PPO inhibitors are those of the formula (III), where

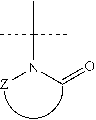

represents a radical of the formula (d), which are hereinafter referred to as compound (III-d). In compounds (III-d), X is in particular F, Y is CH or N and R and Q are as defined herein and in particular together form a radical (i) or (ii). Examples of compounds of the formula (III-c) include trifludimoxazin and 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7) with particular preference given to trifludimoxazin.

In one embodiment of the present invention, the water insoluble pesticidal active in the agrochemical microemulsion composition is dimethenamid-P.

In one especially preferred group of embodiments of the present invention, the water-soluble pesticide A.1 is glufosinate or a salt thereof, in particular L-glufosinate or a salt thereof, and the water insoluble pesticide A.2 in the agrochemical microemulsion composition is dimethenamid-P.

In another particular preferred group of embodiments of the present invention, the watersoluble pesticide A.1 is glufosinate or a salt thereof, in particular L-glufosinate or a salt thereof, and the water insoluble pesticide A.2 in the agrochemical microemulsion composition is selected from the group consisting of pendimethalin, atrazine, S-metolachlor, 2,4-D ester, isoxaflutole, indaziflam, diflufenzopyr, clomazone, sulfentrazone, pyroxasulam, dimethenamid-P, cinmethylin, pyroxasulfone, topramezone, mesotrione, pinoxaden, mesosulfuron, acetochlor, clethodim, propoxycarbazone, propisochlor, bentazone, clomazone, metazachlor, and diflufenican.

In another particular preferred group of embodiments of the present invention, the watersoluble pesticide A.1 is glufosinate or a salt thereof, in particular L-glufosinate or a salt thereof, and the water insoluble pesticide A.2 in the agrochemical microemulsion composition is selected from the group of herbicide compounds of the group of PPO inhibitors, in particular PPO inhibitors of the formula (III), more preferably from the groups PPO inhibitors (III-a), (III-b), (III-c) and (III-d), in particular from the group of compounds especially mentioned as examples of PPO inhibitors (III-a), (III-b), (III-c) and (III-d) and especially PPO inhibitors selected from the group consisting of saflufenacil, flumioxazin, fomesafen and aclonifen.

The microemulsion composition may comprise the dimethenamid-P in a concentration of at least 1 wt %, preferably at least 5 wt % more preferably at least 10 wt %, most preferably at least 15 wt %, in particular at least 20 wt %, based on the total weight of the herbicidal composition. The herbicidal composition may comprise the dimethenamid, in a concentration of up to 50 wt %, preferably up to 40 wt %, more preferably up to 30 wt % based on the total weight of the herbicidal composition. The herbicidal composition may comprise the dimethenamid, in a concentration of from 1 to 50 wt %, preferably 5 to 40 wt %, more preferably 10 to 30 wt %, most preferably 10 to 20 wt % based on the total weight of the herbicidal composition.

Accordingly, the agrochemical composition may comprise water. Typically, the agrochemical composition comprises water in a concentration of at least 1 wt %, preferably at least 5 wt, more preferably at least 10 wt %, most preferably at least 20 wt %. The agrochemical composition may comprise water in a concentration of up to 50 wt %, preferably up to 40 wt %, more preferably up to 30 wt %, and in particular up to 25 wt %. The agrochemical composition typically comprises water in a concentration of from 1 to 50 wt %, preferably from 5 to 30 wt %. If the concentration of water in the agrochemical composition is at least 5 wt %, such compositions may be referred to as aqueous compositions.

The herbicidal composition may also comprise at least one organic solvent. Typically, the agrochemical composition comprises the organic solvent in a concentration of at least 1 wt %, preferably at least 5 wt, more preferably at least 15 wt %. The agrochemical composition may comprise the organic solvent in a concentration of up to 60 wt %, preferably up to 50 wt %, more preferably up to 45 wt %, and in particular up to 35 wt %. The agrochemical composition typically comprises the organic solvent in a concentration of from 5 to 50 wt %, preferably from 10 to 40 wt %. If the concentration of water in the agrochemical composition is at least 20 wt %, such compositions may be referred to as “oily” compositions. Suitable organic solvents are defined herein below. Preferred are such organic solvents that have a water-solubility of at least 1 wt % at 20° C., preferably at least 10 wt % at 20° C. Particularly preferred organic solvents comprise at least one organic solvent, which is completely miscible with water at 20° C. or has a solubility in water of in particular at least 100 g/I at 20° C. and 1 bar.

Suitable organic solvents are aliphatic hydrocarbons, preferably an aliphatic C₅-C₁₆-hydrocarbon, more preferably a C₅-C₁₆-alkane, or C₅-C₁₆-cycloalkane, such as pentane, hexane, cyclohexane, or petrol ether; aromatic hydrocarbons, preferably an aromatic C₆-C₁₀-hydrocarbons, such as benzene, toluene, o-, m-, and p-xylene; halogenated hydrocarbons, preferably halogenated aliphatic C₁-C₆-alkanes, or halogenated aromatic C₆-C₁₀-hydrocarbons, such as CH₂Cl₂, CHCl₃, CCl₄, CH₂ClCH₂Cl, CCl₃CH₃, CHCl₂CH₂Cl, CCl₂CCl₂, or chlorobenzene; ethers, preferably C₁-C₆-cycloalkyl ethers, C₁-C₆-alkyl-C₁-C₆-alkyl ethers and C₁-C₆-alkyl-C₆-C₁₀-aryl ethers, such as CH₃CH₂OCH₂CH₃, (CH₃)₂CHOCH(CH₃)₂, CH₃OC(CH₃)₃(MTBE), CH₃OCH₃ (DME), CH₃OCH₂CH₂OCH₃, dioxane, anisole, and tetrahydrofurane (THF); esters, preferably esters of aliphatic C₁-C₆-alcohols with aliphatic C₁-C₆-carboxylic acids, esters of aromatic C₆-C₁₀-alcohols with aromatic C₆-C₁₀-carboxylic acids, cyclic esters of w-hydroxy-C₁-C₆-carboxylic acids, such as CH₃C(O)OCH₂CH₃, CH₃C(O)OCH₃, CH₃C(O)OCH₂CH₂CH₂CH₃, CH₃C(O)OCH(CH₃)CH₂CH₃, CH₃C(O)OC(CH₃), CH₃CH₂CH₂C(O)OCH₂CH₃, CH₃CH(OH)C(O)OCH₂CH₃, CH₃CH(OH)C(O)OCH₃, CH₃C(O)OCH₂CH(CH₃)₂, CH₃C(O)OCH(CH₃)₂, CH₃CH₂C(O)OCH₃, benzyl benzoate, and γ-butyrolactone; carbonates, such as ethylene carbonate, propylene carbonate, CH₃CH₂OC(O)OCH₂CH₃, and CH₃OC(O)OCH₃; nitriles, preferably C₁-C₆-nitriles, such as CH₃CN, and CH₃CH₂CN; ketones, preferably C₁-C₅-alkyl-C₁-C₅-alkyl ketones, such as CH₃C(O)CH₃, CH₃C(O)CH₂CH₃, CH₃CH₂C(O)CH₂CH₃, and CH₃C(O)C(CH₃)₃(MTBK); alcohols, preferably C₁-C₄-alcohols, such as CH₃OH, CH₃CH₂OH, CH₃CH₂CH₂OH, CH₃CH(OH)CH₃, CH₃(CH₂)₃OH, C(CH₃)₃OH, propylene glycol, dipropylene glycol, propylene glycol monomethylether (1-methoxy-2-propanol); amides and urea derivatives, preferably dimethyl formamide (DMF), N-methyl-2-pyrrolidone (NMP), dimethyl acetamide (DMA), 1,3-dimethyl-2-imidazolidinone (DMI), 1,3-dimethyl-3,4,5,6-tetrahydro-2(1H)-pyrimidinone (DMPU), hexa-methylphosphamide (HMPA); moreover dimethyl sulfoxide (DMSO), and sulfolane.

Preferred organic solvents which are miscible with water are alcohols, preferably C₁-C₄-alcohols, such as CH₃OH, CH₃CH₂OH, CH₃CH₂CH₂OH, CH₃CH(OH)CH₃, CH₃(CH₂)₃OH, C(CH₃)₃OH, propylene glycol, dipropylene glycol, propylene glycol monomethylether (1-methoxy-2-propanol); amides and urea derivatives, preferably dimethyl formamide (DMF), N-methyl-2-pyrrolidone (NMP), dimethyl acetamide (DMA), 1,3-dimethyl-2-imidazolidinone (DMI), 1,3-dimethyl-3,4,5,6-tetrahydro-2(1H)-pyrimidinone (DMPU), hexamethylphosphamide (HMPA); moreover dimethyl sulfoxide (DMSO), and sulfolane.

Particularly preferred organic solvents are propylene glycol, dipropylene glycol and propyleneglycol monomethyl ether, more preferred propylene glycol and dipropylene glycol.

In addition to the aforementioned components A, B, water and the optional organic solvent, the aqueous microemulsions of the present invention may contain one or more further surfactants, which are different from the organosulfate surfactants of the formulae (I) and (II).

The amount these further surfactants will generally not exceed the total amount of the organosulfate surfactants of the formulae (I) and (II) contained in the aqueous microemulsion of the present invention. In particular, the further surfactant is contained in the aqueous microemulsion of the present invention in an amount of 0.1 to 20% by weight, in particular in an amount of 0.2 to 10% by weight, especially in an amount of 0.5 to 5% by weight, based on the total weight of the microemulsion.

Suitable further surfactants are in particular non-ionic surfactants, such as
homo- or copolymers of C₂-C₃-alkyleneoxides, in particular EO homopolymers, PO homopolymers or EO/PO copolymers, such as polyoxyethylene-polyoxypropylene-blockcopolymers;
polyoxy-C₂-C₃-alkylene C₈-C₂₂-alkyl ethers, in particular polyethoxylates and poly-ethoxylates-co-propoxylates of linear or branched C₈-C₂₂-alkanols, more preferably polyethoxylated fatty alcohols and polyethoxylated oxoalcohols, such as polyethoxylated lauryl alcohol, polyethoxylated isotridecanol, polyethoxylated cetyl alcohol, polyethoxylated stearyl alcohol, and esters thereof, such as acetates;
polyoxy-C₂-C₃-alkylene aryl ethers and polyoxy-C₂-C₃-alkylene C₁-C₁₆-alkylaryl ethers, such as polyoxy-C₂-C₃-alkylene C₃-C₂₂-alkylbenzene ethers, in particular polyethoxylates of C₁-C₁₆-alkylphenoles, such as polyethoxylates of nonylphenol, decylphenol, isodecylphenol, dodecylphenol or isotridecylphenol,
polyoxy-C₂-C₃-alkylene mono-, di- or tristyryl phenyl ethers, in particular polyethoxylates of mono-, di-und tristyrylphenoles; and the formaldehyde condensates thereof and the esters thereof, e.g. the acetates;
C₆-C₂₂-alkylglucosides and C₆-C₂₂-alkyl polyglucosides;
polyethoxylates of C₆-C₂₂-alkylglucosides and polyethoxylates of C₆-C₂₂-alkyl polyglucosides;
polyethoxylates of fatty amines;
polyethoxylates of fatty acids and polyethoxylates of hydroxyl fatty acids;
partial esters of polyols with C₆-C₂₂-alkanoic acids, in particular mono- and diesters of glycerine and mono-, di- and triesters of sorbitan, such as glycerine monostearate, sorbitanmonooleat, sorbitantristearat;
polyethoxylates of partial esters of polyols with C₆-C₂₂-alkanoic acids, in particular polyethoxylates of mono- and diesters of glycerine and polyethoxylates of mono-, di- and triesters of sorbitan, such as polyethoxylates of glycerine monostearate, polyethoxylates of sorbitanmonooleat, polyethoxylates of sorbitanmonostearat and polyethoxylates of sorbitantristearat;
polyethoxylates of vegetable oils or animal fats such as corn oil ethoxylate, castor oil ethoxylate, tallow oil ethoxylate;
polyethoxylates of fatty amines, fatty amides or of fatty acid diethanolamides.

The term polyoxy-C₂-C₃-alkylene ether refers to polyether radicals derived from ethylene oxide (EO) or propylene oxide (PO). The term polyethoxylate refers to a polyether radical derived from ethylene oxide. Likewise, the term polyoxyethylene-co-polyoxypropylene refers to a polyether radical derived from a mixture of ethylene oxide and propylene oxide. The number of repeating units in the polyether radicals will generally vary from 2 to 100, frequently from 3 to 100 and in particular from 4 to 50.

Amongst the aforementioned non-ionic surfactants preference is given to the following groups:
polyethoxylates of vegetable oils or animal fats such as corn oil ethoxylate, castor oil ethoxylate, tallow oil ethoxylate;
polyoxy-C₂-C₃-alkylene mono-, di- or tristyryl phenyl ethers, in particular polyethoxylates of mono-, di-und tristyrylphenols;
homo- or copolymers of C₂-C₃-alkyleneoxides, in particular EO homopolymers, PO homopolymers or EO/PO copolymers, such as polyoxyethylene-polyoxypropylene-blockcopolymers.

In particular, the aqueous microemulsions of the present invention contains at least one of the aforementioned non-ionic surfactants in an an amount of 0.1 to 20% by weight, in particular in an amount of 0.2 to 10% by weight, especially in an amount of 0.5 to 5% by weight, based on the total weight of the microemulsion.

Preferably, the aqueous microemulsions of the present invention contains at least one of the following non-ionic surfactants in an an amount of 0.1 to 20% by weight, in particular in an amount of 0.2 to 10% by weight, especially in an amount of 0.5 to 5% by weight, based on the total weight of the microemulsion:
polyethoxylates of vegetable oils or animal fats such as corn oil ethoxylate, castor oil ethoxylate, tallow oil ethoxylate;
polyoxy-C₂-C₃-alkylene mono-, di- or tristyryl phenyl ethers, in particular polyethoxylates of mono-, di-und tristyrylphenols;
homo- or copolymers of C₂-C₃-alkyleneoxides, in particular EO homopolymers, PO homopolymers or EO/PO copolymers, such as polyoxyethylene-polyoxypropylene-blockcopolymers.

Especially, the aqueous microemulsions of the present invention contains at least one of non-ionic surfactant in an an amount of 0.1 to 20% by weight, in particular in an amount of 0.2 to 10% by weight, especially in an amount of 0.5 to 5% by weight, based on the total weight of the microemulsion, where the non-ionic surfactant is selected from the group consisting of polyoxy-C₂-C₃-alkylene di- or tristyryl phenyl ethers, in particular polyethoxylates of di-und tristyrylphenols.

The aqueous microemulsions of the present invention are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

The invention also relates to a method for producing an aqueous agrochemical microemulsion comprising the steps of mixing two organosulfate surfactant components of compounds of formula (I) and of formula (II) to a mixture as defined hereinabove, providing the two pesticides, the water-soluble pesticide and the water-insoluble pesticide, and combining obtained mixture of the organosulfate surfactant components with the two pesticides of step and such that an microemulsion composition as defined hereinabove is obtained.

The invention preferably relates to a method for producing a herbicidal aqueous agrochemical microemulsion comprising the steps of
(a) providing a water-soluble herbicide,
(b) providing a water-insoluble herbicide,
(c) combining two organosulfate surfactant components of compounds of formula (I) and of formula (II) to a mixture as defined hereinabove, and
(d) combining obtained mixture of the organosulfate surfactant components with the two herbicides of step (a) and (b) such that a microemulsion as defined hereinabove is obtained.

The invention preferably relates to a method for producing a herbicidal aqueous agrochemical microemulsion comprising the steps of
(a) providing a water-soluble herbicide selected from a glufosinate salt, preferably the ammonium salt, most preferably L-glufosinate ammonium;
(b) providing a water-insoluble herbicide selected from saflufenacil, pendimethalin, atrazine, S-metolachlor, 2,4-D ester, isoxaflutole, indaziflam, diflufenzopyr, clomazon, sulfentrazone, pyroxasulam, dimethenamid-P, cinmethylin, pyroxasulfone, topramezone, mesotrione, pinoxaden, mesosulfuron, acetochlor, clethodim, propoxycarbazone, propisochlor, bentazone, clomazone, metazachlor, flumioxazin, fomesafen, aclonifen and diflufenican,
(c) combining two organosulfate surfactants components of compounds of formula (I) and of formula (II) to a mixture as defined hereinabove, and
(d) combining obtained mixture of the organosulfate surfactant components with the two herbicides of step (a) and (b) such that a microemulsion as defined hereinabove is obtained.

The herbicidal composition may typically comprise further auxiliaries. Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates. Suitable bactericides are bronopol and isothiazolinone derivatives such as alkylisothiazolinones and benzisothiazolinones. Suitable anti-freezing agents are ethylene glycol, propylene glycol, urea and glycerin.

Suitable anti-foaming agents are silicones, long chain alcohols, and salts of fatty acids. Particularly preferred are silicone-based anti-foaming agents such as polydimethylsiloxanes (e.g. SAG 1572 as available from Momentive, Silcolapse-481 or Silcolapse-482 from Elkem). Suitable silicone-based anti-foaming agents have also been described in WO2005/117590A2,

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

Various types of oils, wetters, adjuvants, fertilizer, or micronutrients, and further pesticides (e.g. herbicides, insecticides, fungicides, growth regulators, safeners) may be added to the herbicidal composition comprising them as premix or, if appropriate not until immediately prior to use (tank mix). These agents can be admixed with the agrochemical compositions according to the invention in a weight ratio of 1:100 to 100:1, preferably 1:10 to 10:1.

The user applies the agrochemical microemulsion composition according to the invention usually from a predosage device, a knapsack sprayer, a spray tank, a spray plane, or an irrigation system. Usually, the herbicidal composition is made up with water, buffer, and/or further auxiliaries to the desired application concentration and the ready-to-use spray liquor or the herbicidal composition according to the invention is thus obtained. Usually, 20 to 2000 liters, preferably 50 to 400 liters, of the ready-to-use spray liquor are applied per hectare of agricultural useful area.

According to one embodiment, individual components of the agrochemical composition according to the invention such as parts of a kit or parts of a binary or ternary mixture may be mixed by the user himself in a spray tank and further auxiliaries may be added, if appropriate.

In a further embodiment, either individual components of the agrochemical composition according to the invention or partially premixed components, e. g. components comprising compounds of formula (I) and (II) and/or the water soluble pesticide or a salt thereof and/or the water insoluble pesticide may be mixed by the user in a spray tank and further auxiliaries and additives may be added, if appropriate.

In a further embodiment, either individual components of the herbicidal composition according to the invention or partially premixed components can be applied jointly (e.g. after tank mix) or consecutively.

The agrochemical compositions according to the present invention have a comparatively low dynamic viscosity and stay homogeneous even at high concentrations of pesticidal active compounds.

The dynamic viscosity as referred to herein can be measured by means of a Brookfield viscosimeter, i.e. a rotational viscosimeter with a cone-plate geometry. The dynamic viscosity may be determined according to industry standard EN ISO 2555:2018. Usually, the dynamic viscosity is measured at 25° C. In this method, the shear rate of the rotation viscosimeter is constantly increased and the shear stress is measured. For Newtonian Fluids, the measurement results in a linear dataset according to a direct proportionality between the shear stress and the shear rate. For non-Newtonian fluids, the measurement results in a non-linear dependency between shear stress and shear rate. The dynamic viscosity, also called apparent viscosity, is typically determined by measuring the slope of a line through the origin of the coordinate system and the shear stress as determined at a shear rate of 100/second. The true viscosity, which may be different from the apparent viscosity for non-Newtonian fluids, is determined by calculating the slope of the tangent of the experimental curve as measured at a shear rate of 100/second.

The agrochemical composition usually has a true viscosity at 20° C. less than to 2000 mPas, preferably less than 1000 mPas, more preferably less than 500 mPas. The agrochemical composition usually has an apparent viscosity at 20° C. less than to 3000 mPas, preferably less than 1500 mPas, more preferably less than 1000 mPas.

Embodiments of Herbicidal Application Methods

Depending on the application method in question, the agrochemical microemulsions according to the invention can be employed for eliminating undesirable pests in crops, such as invertebrate pests, fungi or weeds.
However, the aqueous agrochemical microemulsion of the present invention is preferably used to prepare herbicidal compositions for eliminating weeds in crop plants.

Hence, if at least one of the pesticidal actives is a herbicide, such as glufosinate, the agrochemical microemulsion compositions according to the present invention are suitable as herbicidal compositions. Accordingly, these herbicidal compositions control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Such herbicidal compositions according to the invention are applied to the plants mainly by spraying the leaves. Here, the application can be carried out using, for example, water as carrier by customary spraying techniques using spray liquor amounts of from about 100 to 1000 l/ha (for example from 300 to 400 l/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

When employed in plant protection, the amounts of glufosinate or salt thereof without formulation auxiliaries, are, depending on the kind of effect desired, from 0.001 to 2 kg per ha, preferably from 0.005 to 2 kg per ha, more preferably from 0.05 to 0.9 kg per ha and in particular from 0.1 to 0.75 kg per ha.

When used in the protection of materials or stored products, the amount of glufosinate or salt thereof applied depends on the kind of application area and on the desired effect. Amounts customarily applied in the protection of materials are 0.001 g to 2 kg, preferably 0.005 g to 1 kg, of agrochemical active ingredient per cubic meter of treated material.

Examples of suitable crops are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

The herbicidal compositions according to the invention can also be used in crops which have been modified by mutagenesis or genetic engineering in order to provide a new trait to a plant or to modify an already present trait, preferably a resistance against glufosinate or its salts.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicides: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO-Ø1981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants. In particular genes coding for protease inhibitors, like CpTI and pinII. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-ØØ41Ø-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase), as well as in patent applications, like EP3028573 and WO2017/011288.

The use of herbicidal compositions according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigour, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the herbicidal compositions according to the invention are also suitable for the defoliation and/or desiccation of plant parts, for which crop plants such as cotton, potato, oilseed rape, sunflower, soybean or field beans, in particular cotton, are suitable. In this regard herbicidal compositions have been found for the desiccation and/or defoliation of plants, processes for preparing these compositions, and methods for desiccating and/or defoliating plants using the herbicidal compositions according to the invention.

As desiccants, herbicidal compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The herbicidal composition may be applied in or on permanent cropland, or on permanent crops.

A permanent crop is one produced from plants which last for many seasons, rather than being re-planted after each harvest. Permanent crops are grown on permanent crop land in the form of agricultural land that includes grasslands and shrublands, e.g. used to grow grape vines or coffee; orchards used to grow fruit or olives; and forested plantations, e.g. used to grow nuts or rubber. It does not include, however, tree farms intended to be used for wood or timber.

Preferred permanent croplands in the context of the present invention are plantations, grasslands and shrublands. Preferably, the permanent crops in the context of the present invention are plantation crops, and preferably are selected from the group consisting fruit crops and orchard crops (preferably fruit trees, citrus trees, mango trees, olive trees, grape vines, coffee, cocoa, tea, and berries (such as strawberries, raspberries, blueberries and currants)), Musaceae sp. crops (for example banana or plantain crops), nut trees (preferably almond trees, walnut trees, pistachio trees, pecan trees, hazelnut trees), oil palm trees, rubber trees, sugarcane and cotton.

More preferably, the permanent crops are fruit trees (preferably pome fruit trees and stone fruit trees; preferred fruit trees are apple trees, pear trees, apricot trees, plum trees, cherry trees, peach trees), olive trees, grape vines, coffee, tea), Musaceae sp. crops (preferably banana crops or plantain crops), nut trees (preferably almond trees, walnut trees, pistachio trees, pecan trees, hazelnut trees), oil palm trees, rubber trees, and citrus crops (preferably lemon, orange or grapefruit crops). Even more preferably, the permanent crops are selected from the group consisting of apple trees, pear trees, apricot trees, plum trees, cherry trees, peach trees, olive trees, grape vines, coffee, tea, banana crops, nut trees (preferably almond trees, walnut trees, pistachio trees), oil palm trees, rubber trees, and citrus crops (preferably lemon, orange or grapefruit crops). Particularly preferably, the permanent crops are selected from the group consisting of apple trees, pear trees, apricot trees, plum trees, cherry trees, peach trees, olive trees, grape vines, coffee, tea, banana crops, almond trees, walnut trees, oil palm trees, rubber trees, lemon crops, orange crops and grapefruit crops

The herbicidal composition may also be applied on row crops and as well on specialty crops.

Row crops can be planted in rows wide enough to allow it to be tilled or otherwise cultivated by agricultural machinery, machinery tailored for the seasonal activities of row crops. The particularity of row crops is that they are planted and cultivated on a seasonal or yearly basis. Therefore, such crops yield products and profit relatively quickly and predictably. A row crop is one produced from plants which last for many seasons, rather than being re-planted after each harvest. Examples of row crops include soybeans, corn, canola, cotton, cereals or rice, but as well sunflower, potato, dry bean, field pea, flax, safflower, buckwheat and sugar beets.

Specialty crops are to be understood as fruits, vegetables or other specialty or plantation permanent crops such as trees, nuts, vines, (dried) fruits, ornamentals, oil palm, banana, rubber and the like, Horticulture and nursery crops, including floriculture, may also fall under the definition of specialty crops. Vegetable crops includes for example aubergine, beans, bell pepper, cabbage, chili, cucumber, eggplant, lettuce, melon, onion, potato, sweet potato, spinach and tomato. Plants being considered specialty crops are in general intensively cultivated. For weed control in vegetable crops, it may be desirable to shield the crops from contact with the spray solution that contains the herbicidal mixture according to the present invention.

In general, the crops which may be treated, may be of conventional origin or may be herbicide tolerant crops, preferably glufosinate tolerant crops. The herbicidal composition shows high herbicidal effects also against select crop plants, such as barley and soybean. This effect can be used to control crop plants in crop rotation methods of previously grown crop cultures. Typically, residual crop plants from previous rotation cycles remain after harvest and continue to grow within the subsequently grown crop variety. This reduces the yield since the crop plants of two different crop rotation cycles compete on the same locus of growth. The herbicidal composition may thus be applied to control residual crop plants from previous crop rotation cycles to allow for a homogeneous coverage with the subsequent crop plant.

In a preferred embodiment, the herbicidal composition is applied once, twice or three times per Gregorian calendar year, i.e. in one application, in two applications or in three applications per year according to the Gregorian calendar. In a preferred embodiment, the herbicidal composition is applied twice per Gregorian calendar year, i.e. in two applications per year according to the Gregorian calendar. In an alternatively preferred embodiment, the herbicidal composition is applied one time per Gregorian calendar year, i.e. in one application per year according to the Gregorian calendar. In a preferred embodiment, the herbicidal composition is applied one time in about 12 months, i.e. in one application in about 12 months. In an alternative preferred embodiment, the herbicidal composition is applied between one and ten times per Gregorian calendar year, i.e. in up to ten applications per year according to the Gregorian calendar. This alternative preferred method is of particular usefulness in permanent crops, in particular those grown under tropical conditions; in which case weeds grow vigorously at any time of the year, and herbicide applications are to be re-peated as soon as the previous treatment loses its effectiveness and weeds start to regrow.

The herbicidal compositions are preferably used in post-emergence applications.

The invention includes the use and methods of application of the herbicidal composition for controlling undesirable vegetation in crops in a burndown program, wherein the crop is produced by genetic engineering or by breeding, are tolerant to one or more herbicides and/or resistant to pathogens such as plant-pathogenous fungi, and/or to attack by insects; preferably tolerant to glufosinate.

Preferred are crops, which are tolerant to glufosinate, wherein the glufosinate tolerant crop plant is preferably selected from the group consisting of rice, canola, soybean, corn and cotton plants.

Transgenic corn events comprising glufosinate tolerance genes are for example, but not excluding others, 5307×MIR6Ø4×Bt11×TC1507×GA21×MIR162 (event code: SYN-Ø53Ø7-1×SYN-IR6Ø4-5×SYN-BTØ11-1×DAS-Ø15Ø7-1×MON-ØØØ21-9×SYN-IR162-4, gene: pat, e.g. commercially available as Agrisure® Duracade™ 5222), 59122 (event code: DAS-59122-7, gene: pat, e.g. commercially available as Herculex™ RW), 5307×MIR6Ø4×Bt11×TC1507×GA21 (event code: SYN-05307-1×SYN-IR6Ø4-5×SYN-BTØ11-1×DAS-Ø15Ø7-1×MON-ØØØ21-9, gene: pat, e.g. commercially available as Agrisure® Duracade™ 5122), 59122×NK603 (event code: DAS-59122-7×MON-ØØ6Ø3-6, gene: pat, e.g. commercially available as Herculex™ RW Roundup Ready™ 2), Bt10 (gene: pat, e.g. commercially available as Bt10), Bt11 (X4334CBR, X4734CBR) (event code: SYN-BTØ11-1, gene: pat, e.g. commercially available as Agrisure™ CB/LL), BT11×59122×MIR6Ø4×TC1507×GA21 (event code: SYN-BTØ11-1×DAS-59122-7×SYN-IR6Ø4-5×DAS-Ø15Ø7-1×MON-ØØØ21-9, gene: pat, e.g. commercially available as Agrisure® 3122), Bt11×GA21 (event code: SYN-BTØ11-1×MON-ØØØ21-9, gene: pat, e.g. commercially available as Agrisure™ GT/CB/LL), Bt11×MIR162 (event code: SYN-BTØ11-1×SYN-IR162-4, gene: pat, e.g. commercially available as Agrisure® Viptera™ 2100), Bt11×MIR162×GA21 (event code: SYN-BTØ11-1×SYN-IR162-4×MON-ØØØ21-9, gene: pat, e.g. commercially available as Agrisure® Viptera™ 3110), BT11×MIR162×MIR6Ø4 (event code: SYN-BTØ11-1×SYN-IR162-4×SYN-IR6Ø4-5, gene: pat, e.g. commercially available as Agrisure® Viptera™ 3100), Bt11×MIR162×MIR6Ø4×GA21 (event code: SYN-BTØ11-1×SYN-IR162-4×SYN-IR6Ø4-5×MON-ØØØ21-9, gene: pat, e.g. commercially available as Agrisure® Viptera™ 3111, Agrisure® Viptera™ 4), Bt11×MIR162×TC1507×GA21 (event code: SYN-BTØ11-1×SYN-IR162-4×DAS-Ø15Ø7-1×MON-ØØØ21-9, gene: pat, e.g. commercially available as Agrisure™ Viptera 3220), Bt11×MIR6Ø4 (event code: SYN-BTØ11-1×SYN-IR6Ø4-5, gene: pat, e.g. commercially available as Agrisure™ CB/LL/RW), BT11×MIR6Ø4×GA21 (event code: SYN-BTØ11-1×SYN-IR6Ø4-5×MON00021-9, gene: pat, e.g. commercially available as Agrisure™ 3000GT), Bt176 (176) (event code: SYN-EV176-9, gene: bar, e.g. commercially available as NaturGard KnockOut™, Maximizer™), CBH-351 (event code: ACS-ZM004-3, gene: bar, e.g. commercially available as Starlink™ Maize), DBT418 (event code: DKB-89614-9, gene: bar, e.g. commercially available as Bt Xtra™ Maize), MON89034×TC1507×MON88017×59122 (event code: MON-89Ø34-3×DASØ15Ø7-1×MON-88Ø17-3×DAS-59122-7, gene: pat, e.g. commercially available as Genuity® SmartStax™), MON89034×TC1507×NK603 (event code: MON-89Ø34-3×DAS-Ø15Ø7-1×MON-ØØ6Ø3-6, gene: pat, e.g. commercially available as Power Core™), NK603×T25 (event code: MON-ØØ6Ø3-6×ACS-ZM003-2, gene: pat, e.g. commercially available as Roundup Ready™ Liberty Link™ Maize), T14 (event code: ACS-ZM002-1, gene: pat, e.g. commercially available as Liberty Link™ Maize), T25 (event code: ACS-ZM003-2, gene: pat, e.g. commercially available as Liberty Link™ Maize), T25×MON810 (event code: ACS-ZM003-2×MON-ØØ81Ø-6, gene: pat, e.g. commercially available as Liberty Link™ Yieldgard™ Maize), TC1507 (event code: DAS-Ø15Ø7-1, gene: pat, e.g. commercially available as Herculex™ I, Herculex™ CB), TC1507×59122×MON810×MIR604×NK603 (event code: DAS-Ø15Ø7-1×DAS59122-7×MON-ØØ81Ø-6×SYN-IR6Ø4-5×MON-ØØ6Ø3, gene: pat, e.g. commercially available asOptimum™ Intrasect Xtreme), TC1507×59122 (event code: DAS-Ø15Ø7-1×DAS-59122-7, gene: pat, e.g. commercially available as Herculex XTRA™), TC1507×59122×MON810×NK603 (event code: DAS-Ø15Ø7-1×DAS-59122-7×MON-ØØ81Ø-6×MON00603-6, gene: pat, e.g. commercially available as Optimum™ Intrasect XTRA), TC1507×59122×NK603 (event code: DAS-Ø15Ø7-1×DAS-59122-7×MON-ØØ6Ø3-6, gene: pat, e.g. commercially available as Herculex XTRA™ RR), TC1507×MIR6Ø4×NK603 (event code: DAS-Ø15Ø7-1×SYN-IR6Ø4-5×MON-ØØ6Ø3-6, gene: pat, e.g. commercially available as Optimum™ TRIsect), TC1507×MON810×NK603 (event code: DAS-Ø15Ø7-1×MON-ØØ81Ø-6×MON-ØØ6Ø3-6, gene: pat, e.g. commercially available as Optimum™ Intrasect), TC1507×NK603 (event code: DAS-Ø15Ø7-1×MON-ØØ6Ø3-6, gene: pat, e.g. commercially available as Herculex™ I RR), 3272×Bt11 (event code: SYN-E3272-5×SYN-BTØ11-1 gene: pat), 3272×Bt11×GA21 (event code: SYN-E3272-5×SYN-BTØ11-1×MON-ØØØ21-9, gene: pat), 3272×Bt11×MIR6Ø4 (event code: SYN-E3272-5×SYN-BTØ11-1×SYN-IR6Ø4-5, gene: pat), 3272×BT11×MIR6Ø4×GA21 (event code: SYN-E3272-5×SYN-BTØ11-1×SYN-IR6Ø4-5×MON-ØØØ21-9, gene: pat), 33121 (event code: DP-Ø33121-3, gene: pat), 4114 (event code: DP-ØØ4114-3, gene: pat), 59122×GA21 (event code: DAS-59122-7×MON-ØØØ21-9, gene: pat), 59122×MIR6Ø4 (event code: DAS-59122-7×SYN-IR6Ø4-5, gene: pat), 5307×MIR6Ø4×Bt11×TC1507×GA21×MIR162 (event code: gene: pat), 59122×MIR604×GA21 (event code: DAS-59122-7×SYN-IR6Ø4-5×MON-ØØØ21-9, gene: pat), 59122×MIR604×TC1507 (event code: DAS-59122-7×SYN-IR6Ø4-5×DAS-Ø15Ø7-1, gene: pat), 59122×MIR604×TC1507×GA21 (event code: gene: pat), (event code: DAS-59122-7×SYN-IR6Ø4-5×DAS-Ø15Ø7-1×MON-ØØØ21-9, gene: pat), 59122×MON810 (event code: DAS-59122-7×MON-ØØ81Ø-6, gene: pat), 59122×MON810×NK603 (event code: DAS-59122-7×MON-ØØ81Ø-6×MON-ØØ6Ø3-6, gene: pat), 59122×TC1507×GA21 (event code: DAS-59122-7×DAS-Ø15Ø7-1×MON-ØØØ21-9, gene: pat), 676 (event code: PH-ØØØ676-7, gene: pat), 678 (event code: PHØØØ678-9, gene: pat), 680 (event code: PH-ØØØ68Ø-2, gene: pat), 98140×59122 (event code: DP-Ø9814Ø-6×DAS-59122-7, gene: pat), 98140×TC1507 (event code: DP-Ø9814Ø-6×DAS-Ø15Ø7-1, gene: pat), 98140×TC1507×59122 (event code: DP-Ø9814Ø-6×DAS-Ø15Ø7-1×DAS-59122-7, gene: pat), 59122×MON88017 (event code: DAS-59122-7×MON-88Ø17-3, gene: pat), Bt11×59122 (event code: SYN-BTØ11-1×DAS-59122-7, gene: pat), Bt11×59122×GA21 (event code: SYN-BTØ11-1×DAS-59122-7×MON-ØØØ21-9, gene: pat), Bt11×59122×MIR604 (event code: SYN-BTØ11-1×DAS-59122-7×SYN-IR6Ø4-5, gene: pat), Bt11×59122×MIR604×GA21 (event code: SYN-BTØ11-1×DAS-59122-7×SYN-IR6Ø4-5×MON-ØØØ21-9, gene: pat), Bt11×59122×MIR604×TC1507 (event code: Bt11×59122×MIR604×TC1507, gene: pat), Bt11×59122×TC1507 (event code: SYN-BTØ11-1×DAS-59122-7×DAS-Ø15Ø7-1, gene: pat), Bt11×59122×TC1507×GA21 (event code: SYN-BTØ11-1×DAS-59122-7×DAS-Ø15Ø7-1×MON-ØØØ21-9, gene: pat), Bt11×MIR162×TC1507 (event code: SYN-BTØ11-1×SYN-IR162-4×DAS-Ø15Ø7-1, gene: pat), Bt11×MIR604×TC1507 (event code: SYN-BTØ11-1×SYN-IR6Ø4-5×DAS-Ø15Ø7-1, gene: pat), Bt11×TC1507 (event code: SYN-BTØ11-1×DAS-Ø15Ø7-1, gene: pat), Bt11×TC1507×GA21 (event code: SYN-BTØ11-1×DAS-Ø15Ø7-1×MON-ØØØ21-9, gene: pat), GA21×T25 (event code: MON-ØØØ21-9×ACS-ZMØØ3-2, gene: pat), MIR162×TC1507 (event code: SYN-IR162-4×DAS-Ø15Ø7-1, gene: pat), MIR162×TC1507×GA21 (event code: SYN-IR162-4×DAS-Ø15Ø7-1×MON-ØØØ21-9, gene: pat), MIR604×TC1507 (event code: SYN-IR6Ø4-5×DAS-Ø15Ø7-1, gene: pat), MON87427×MON89Ø34×TC15Ø7×MON88Ø17×59122 (event code: MON-87427-7×MON-89Ø34-3×DAS-Ø15Ø7-1×MON-88Ø17-3×DAS-59122-7, gene: pat), MON89034×59122 (event code: MON-89Ø34-3×DAS-59122-7, gene: pat), MON89034×59122×MON88017 (event code: gene: pat), MON89034×TC1507 (event code: MON-89Ø34-3×DAS-59122-7×MON-88Ø17-3, gene: pat), (event code: MON-89Ø34-3×DAS-Ø15Ø7-1, gene: pat), MIR604×TC1507 (event code: SYN-IR6Ø4-5×DAS-Ø15Ø7-1, gene: pat), MON87427×MON89Ø34×TC15Ø7×MON88Ø17×59122 (event code: MON87427-7×MON-89Ø34-3×DAS-Ø15Ø7-1×MON-88Ø17-3×DAS-59122-7, gene: pat), MON89034×59122 (event code: MON-89Ø34-3×DAS-59122-7, gene: pat), MON89034×59122×MON88017 (event code: gene: pat), MON89034×TC1507 (event code: MON-89Ø34-3×DAS-59122-7×MON-88Ø17-3, gene: pat), (event code: MON-89Ø34-3×DAS-Ø15Ø7-1, gene: pat), DLL25 (B16) (event code: DKB-8979Ø-5, gene: bar), MIR604×TC1507 (event code: SYN-IR6Ø4-5×DAS-Ø15Ø7-1, gene: pat), MON87427×MON89Ø34×TC15Ø7×MON88Ø17×59122 (event code: MON-87427-7×MON-89Ø34-3×DAS-Ø15Ø7-1×MON88Ø17-3×DAS-59122-7, gene: pat), MON89034×59122 (event code: MON-89Ø34-3×DAS59122-7, gene: pat), MON89034×59122×MON88017 (event code: MON-89Ø34-3×DAS59122-7×MON-88Ø17-3, gene: pat), MON89034×TC1507 (event code: MON-89Ø34-3×DAS-Ø15Ø7-1, gene: pat), MON89034×TC1507×59122 (event code: MON-89Ø34-3×DASØ15Ø7-1×DAS-59122-7, gene: pat), MON89034×TC1507×MON88017 (event code: MON89Ø34-3×DAS-Ø15Ø7-1×MON-88Ø17-3, gene: pat), MON89034×TC1507×MON88017×59122×DAS40278 (event code: MON-89Ø34-3×DAS-Ø15Ø7-1×MON-88Ø17-3×DAS59122-7×DAS-4Ø278-9, gene: pat), MON89034×TC1507×MON88017×DAS40278 (event code: MON-89Ø34-3×DAS-Ø15Ø7-1×MON-88Ø17-3×DAS-59122-7×DAS-4Ø278-9, gene: pat), MON89034×TC1507×NK603×DAS40278 (event code: MON-89Ø34-3×DAS-Ø15Ø7-1×MON-ØØ6Ø3-6×DAS-4Ø278-9, gene: pat), NK603×MON810×4114×MIR 604 (event code: MON-00603-6×MON-00810-6×DP004114-3×SYN-IR6Ø4-4, gene: pat), TC1507×MON810×MIR604×NK603 (event code: DAS-Ø15Ø7-1×MON-ØØ81Ø-6×SYN-IR6Ø4-5×MON-ØØ6Ø3-6, gene: pat), TC1507×59122×MON810 (event code: DAS-Ø15Ø7-1×DAS59122-7×MON-ØØ81Ø-6, gene: pat), TC1507×59122×MON88017 (event code: DASØ15Ø7-1×DAS-59122-7×MON-88Ø17-3, gene: pat), TC1507×GA21 (event code: DASØ15Ø7-1×MON-ØØØ21-9, gene: pat), TC1507×MON810 (event code: DAS-Ø15Ø7-1×MON-ØØ81Ø-6, gene: pat), TC1507×MON810×MIR162×NK603 (event code: DAS-Ø15Ø7-1×MON-ØØ81Ø-6×SYN-IR162-4×MON-ØØ6Ø3-6, gene: pat), 3272×Bt11×MIR604×TC1507×5307×GA21 (event code: SYN-E3272-5×SYN-BTØ11-1×SYN-IR6Ø4-5×DASØ15Ø7-1×SYN-Ø53Ø7-1×MON-ØØØ21-9, gene: pat), TC1507×MIR162×NK603 (event code: DAS-Ø15Ø7-1×SYN-IR162-4×MON-ØØ6Ø3-6, gene: pat), TC1507×MON810×MIR162 (event code: DAS-Ø15Ø7-1×MON-ØØ81Ø-6×SYN-IR162-4, gene: pat), MON87419 (event code: MON87419-8, gene: pat), TC1507×MON88017 (event code: DAS-Ø15Ø7-1×MON-88Ø17-3, gene: pat), TC6275 (event code: DAS-Ø6275-8, gene: bar), MZHGOJG (event code: SYN-ØØØJG-2, gene: pat), MZIR098 (event code: SYN-ØØØ98-3, gene: pat), Bt11×MIR162×MON89034 (event code: SYN-BTØ11-1×SYN-IR162-4×MON-89Ø34-3, gene: pat) and Bt11×MIR162×MON89Ø34×GA21 (event code: SYN-BTØ11-1×SYN-IR162-4×MON89Ø34-3×MON-ØØØ21-9, gene: pat), 59122×DAS40278 (event code: DAS-59122-7×DAS4Ø278-9, gene: pat), 59122×MON810×MIR604 (event code: DAS-59122-7×MON-ØØ81Ø-6×SYN-IR6Ø4-5, gene: pat), 59122×MON810×NK603×MIR604 (event code: DAS-59122-7×MON-ØØ81Ø-6×MON-ØØ6Ø3-6×SYN-IR6Ø4-5, gene: pat), 59122×MON88017×DAS40278 (event code: DAS-59122-7×MON-88Ø17-3×DAS-40278-9, gene: pat), 59122×NK603×MIR604 (event code: DAS-59122-7×MON-ØØ6Ø3-6×SYN-IR6Ø4-5, gene: pat), Bt11×5307 (event code: SYN-BTØ11-1×SYN-Ø53Ø7-1, gene: pat), Bt11×5307×GA21 (event code: SYN-BTØ11-1×SYN-Ø53Ø7-1×MON-ØØØ21-9, gene: pat), Bt11×MIR162×5307 (event code: SYN-BTØ11-1×SYN-IR162-4×SYN-Ø53Ø7-1, gene: pat), Bt11×MIR162×5307×GA21 (event code: SYN-BTØ11-1×SYN-IR162-4×SYN-Ø53Ø7-1×MON-ØØØ21-9, gene: pat), BT11×MIR162×MIR604×5307 (event code: SYN-BTØ11-1×SYN-IR162-4×SYN-IR6Ø4-5×SYN-Ø53Ø7-1, gene: pat), Bt11×MIR162×MIR604×5307×GA21 (event code: SYN-BTØ11-1×SYN-IR162-4×SYN-IR6Ø4-5×SYN-Ø53Ø7-1×MON-ØØØ21-9, gene: pat), Bt11×MIR162×MIR604×MON89034×5307×GA21 (event code: SYN-BTØ11-1×SYN-IR162-4×SYN-IR6Ø4-5×MON-89Ø34-3×SYN-Ø53Ø7-1×MON-ØØØ21-9, gene: pat), BT11×MIR162×MIR604×TC1507 (event code: SYN-BTØ11-1×SYN-IR162-4×SYN-IR6Ø4-5×DAS-Ø15Ø7-1, gene: pat), BT11×MIR162×MIR604×TC1507×5307 (event code: SYN-BTØ11-1×SYN-IR162-4×SYN-IR6Ø4-5×DAS-Ø15Ø7-1×SYN-Ø53Ø7-1, gene: pat), Bt11×MIR162×MIR604×TC1507×GA21 (event code: SYN-BTØ11-1×SYN-IR162-4×SYN-IR6Ø4-5×DAS-Ø15Ø7-1×MON-ØØØ21-9, gene: pat), Bt11×MIR162×TC1507×5307 (event code: SYN-BTØ11-1×SYN-IR162-4×DAS-Ø15Ø7-1×SYN-Ø53Ø7-1, gene: pat), BT11×MIR162×MIR604×TC1507×5307 (event code: SYN-BTØ11-1×SYN-IR162-4×SYN-IR6Ø4-5×DASØ15Ø7-1×SYN-Ø53Ø7-1, gene: pat), Bt11×MIR162×MIR604×TC1507×GA21 (event code: SYN-BTØ11-1×SYN-IR162-4×SYN-IR6Ø4-5×DAS-Ø15Ø7-1×MON-ØØØ21-9, gene: pat), Bt11×MIR162×TC1507×5307 (event code: SYN-BTØ11-1×SYN-IR162-4×DAS-Ø15Ø7-1×SYN-Ø53Ø7-1, gene: pat), Bt11×MIR162×TC1507×5307×GA21 (event code: SYN-BTØ11-1×SYN-IR162-4×DAS-Ø15Ø7-1×SYN-Ø53Ø7-1×MON-ØØØ21-9, gene: pat), Bt11×MIR604×5307 (event code: SYN-BTØ11-1×SYN-IR6Ø4-5×SYN-Ø53Ø7-1, gene: pat), Bt11×MIR604×5307×GA21 (event code: SYN-BTØ11-1×SYN-IR6Ø4-5×SYN-Ø53Ø7-1×MONØØØ21-9, gene: pat), Bt11×MIR604×TC1507×5307 (event code: SYN-BTØ11-1×SYN-IR6Ø4-5×DAS-Ø15Ø7-1×SYN-Ø53Ø7-1, gene: pat), Bt11×MIR604×TC1507×GA21 (event code: SYN-BTØ11-1×SYN-IR6Ø4-5×DAS-Ø15Ø7-1×MON-ØØØ21-9, gene: pat), Bt11×MON89034 (or Bt11×MON89Ø34) (event code: SYN-BTØ11-1×MON-89Ø34-3, gene: pat), Bt11×MON89034×GA21 (event code: SYN-BTØ11-1×MON-89Ø34-3×MON-ØØØ21-9, gene: pat), Bt11×MON89Ø34×GA21 (event code: SYN-BTØ11-1×MON-89Ø34-3×MON-ØØØ21-9, gene: pat), Bt11×TC1507×5307 (event code: SYN-BTØ11-1×DAS-Ø15Ø7-1×SYN-Ø53Ø7-1, gene: pat), Bt11×TC1507×5307×GA21 (event code: SYN-BTØ11-1×DASØ15Ø7-1×SYN-Ø53Ø7-1×MON-ØØØ21-9, gene: pat), MIR162×MIR604×TC1507×5307 (event code: SYN-IR162-4×SYN-IR6Ø4-5×DAS-Ø15Ø7-1×SYN-Ø53Ø7-1, gene: pat), MIR162×MIR604×TC1507×5307×GA21 (event code: SYN-IR162-4×SYN-IR6Ø4-5×DASØ15Ø7-1×SYN-Ø53Ø7-1×MON-ØØØ21-9, gene: pat), MIR162×MIR604×TC1507×GA21 (event code: SYN-IR162-4×SYN-IR6Ø4-5×DAS-Ø15Ø7-1×MON-ØØØ21-9, gene: pat), MIR162×TC1507×5307 (event code: SYN-IR162-4×DAS-Ø15Ø7-1×SYN-Ø53Ø7-1, gene: pat), MIR162×TC1507×5307×GA21 (event code: SYN-IR162-4×DAS-Ø15Ø7-1×SYN-Ø53Ø7-1×MON-ØØØ21-9, gene: pat), MIR604×TC1507×5307 (event code: SYN-IR6Ø4-5×DAS-Ø15Ø7-1×SYN-Ø53Ø7-1, gene: pat), MIR162×TC1507×5307 (event code: SYN-IR162-4×DAS-Ø15Ø7-1×SYN-Ø53Ø7-1, gene: pat), MIR162×TC1507×5307×GA21 (event code: SYN-IR162-4×DAS-Ø15Ø7-1×SYN-Ø53Ø7-1×MON-ØØØ21-9, gene: pat), MIR604×TC1507×5307 (event code: SYN-IR6Ø4-5×DAS-Ø15Ø7-1×SYN-Ø53Ø7-1, gene: pat), MIR604×TC1507×5307×GA21 (event code: SYN-IR6Ø4-5×TC1507×SYN-Ø53Ø7-1×MON-ØØØ21-9, gene: pat), MIR604×TC1507×GA21 (event code: SYN-IR6Ø4-5×TC1507×MON-ØØØ21-9, gene: pat), MON87427×59122 (event code MON-87427-7×DAS-59122-7: gene: pat), MON87427×MON89034×59122 (event code: MON-87427-7×MON-89Ø34-3×DAS-59122-7, gene: pat), MON87427×MON89034×MON88017×59122 (event code: MON-87427-7×MON-89Ø34-3×MON-88Ø17-3×59122, gene: pat), MON87427×MON89034×TC1507 (event code: MON-87427-7×MON-89Ø34-3×DAS-Ø15Ø7-1, gene: pat), MON87427×MON89034×TC1507×59122 (event code: MON-87427-7×MON-89Ø34-3×DAS-Ø15Ø7-1×DAS-59122-7, gene: pat), MON87427×MON89034×TC1507×MON87411×59122 (event code: MON-87427-7×MON-89Ø34-3×DAS-Ø15Ø7-1×MON-87411-9×DAS-59122-7, gene: pat), MON87427×MON89034×TC1507×MON87411×59122×DAS40278 (event code: MON-87427-7×MON-89Ø34-3×DAS-Ø15Ø7-1×MON-87411-9×DAS-59122-7×DAS4Ø278-9, gene: pat), MON87427×MON89034×TC1507×MON88017 (event code: MON87427-7×MON-89Ø34-3×DAS-Ø15Ø7-1×MON-88Ø17-3, gene: pat), MON87427×TC1507 (event code: MON-87427-7×DAS-Ø15Ø7-1, gene: pat), MON87427×TC1507×59122 (event code: MON-87427-7×DAS-Ø15Ø7-1×DAS-59122-7, gene: pat), MON87427×TC1507×MON88017 (event code: MON-87427-7×DAS-Ø15Ø7-1×MON-88Ø17-3, gene: pat), MON87427×TC1507×MON88017×59122 (event code: MON-87427-7×DAS-Ø15Ø7-1×MON-88Ø17-3×DAS-59122-7, gene: pat), MON89034×59122×DAS40278 (event code: MON-89Ø34-3×DAS-59122-7×DAS-40278-9, gene: pat), MON89034×59122×MON88017×DAS40278 (event code: MON-89Ø34-3×DAS-59122-7×MON-88Ø17-3×DAS-40278-9, gene: pat), MON89034×TC1507×59122×DAS40278 (event code: MON-89Ø34-3×DASØ15Ø7-1×DAS-59122-7×DAS-4Ø278-9, gene: pat), MON89034×TC1507×DAS40278 (event code: MON-89Ø34-3×DAS-Ø15Ø7-1×DAS-40278-9, gene: pat), MON89034×TC1507×NK603×MIR162 (event code: MON-89Ø34-3×DAS-Ø15Ø7-1×MON-ØØ6Ø3-6×SYN-IR162-4, gene: pat), TC1507×5307 (event code: DAS-Ø15Ø7-1×SYN-Ø53Ø7-1, gene: pat), TC1507×5307×GA21 (event code: DAS-Ø15Ø7-1×SYN-Ø53Ø7-1×MON-ØØØ21-9, gene: pat), TC1507×59122×DAS40278 (event code: DAS-Ø15Ø7-1×DAS-59122-7×DAS4Ø278-9, gene: pat), TC1507×59122×MON810×MIR604 (event code: DAS-Ø15Ø7-1×DAS-59122-7×MON-ØØ81Ø-6×SYN-IR6Ø4-5, gene: pat), TC1507×59122×MON88017×DAS40278 (event code: DAS-Ø15Ø7-1×DAS-59122-7×MON-88Ø17-3×DAS-4Ø278-9, gene: pat), TC1507×59122×NK603×MIR604 (event code: gene: pat) DAS-Ø15Ø7-1×DAS-59122-7×MON-ØØ6Ø3-6×SYN-IR6Ø4-5, TC1507×DAS40278 (event code: DAS-Ø15Ø7-1×DAS-4Ø278-9, gene: pat), TC1507×MON810×MIR604 (event code: DAS-Ø15Ø7-1×MONØØ81Ø-6×SYN-IR6Ø4-5, gene: pat), TC1507×MON810×NK603×MIR604 (event code: DAS-Ø15Ø7-1×MON-ØØ81Ø-6×MON-ØØ6Ø3-6×SYN-IR6Ø4-5, gene: pat), TC1507×MON88017×DAS40278 (event code: DAS-Ø15Ø7-1×MON-88Ø17-3×DAS-40278-9, gene: pat) and TC1507×NK603×DAS40278 (event code: DAS-Ø15Ø7-1×MON-ØØ6Ø3-6×DAS4Ø278-9, gene: pat).

Transgenic soybean events comprising glufosinate tolerance genes are for example, but not excluding others, A2704-12 (event code: ACS-GMØØ5-3, gene: pat, e.g. commercially available as Liberty Link™ soybean), A2704-21 (event code: ACS-GMØØ4-2, gene: pat, e.g. commercially available as Liberty Link™ soybean), A5547-127 (event code: ACS-GMØØ6-4, gene: pat, e.g. commercially available as Liberty Link™ soybean), A5547-35 (event code: ACSGMØØ8-6, gene: pat, e.g. commercially available as Liberty Link™ soybean), GU262 (event code: ACS-GMØØ3-1, gene: pat, e.g. commercially available as Liberty Link™ soybean), W62 (event code: ACS-GMØØ2-9, gene: pat, e.g. commercially available as Liberty Link™ soybean), W98 (event code: ACS-GMØØ1-8, gene: pat, e.g. commercially available as Liberty Link™ soybean), DAS68416-4 (event code: DAS-68416-4, gene: pat, e.g. commercially available as Enlist™ Soybean), DAS44406-6 (event code: DAS-444Ø6-6, gene: pat), DAS68416-4×MON89788 (event code: DAS-68416-4×MON-89788-1, gene: pat), SYHTØH2 (event code: SYN-ØØØH2-5, gene: pat), DAS81419×DAS44406-6 (event code: DAS-81419-2×DAS444Ø6-6, gene: pat) and FG72×A5547-127 (event code: MST-FGØ72-3×ACS-GMØØ6-4, gene: pat).

Transgenic cotton events comprising glufosinate tolerance genes are for example, but not excluding others, 3006-210-23×281-24-236×MON1445 (event code: DAS-21Ø23-5×DAS24236-5×MON-Ø1445-2, gene: bar, e.g. commercially available as WideStrike™ Roundup Ready™ Cotton), 3006-210-23×281-24-236×MON88913 (event code: DAS-21Ø23-5×DAS24236-5×MON-88913-8, gene: bar, e.g. commercially available as Widestrike™ Roundup Ready Flex™ Cotton), 3006-210-23×281-24-236×MON88913×COT102 (event code: DAS21Ø23-5×DAS-24236-5×MON-88913-8×SYN-IR1Ø2-7, gene: pat, e.g. commercially available as Widestrike™×Roundup Ready Flex™×VIPCOT™ Cotton), GHB614×LLCotton25 (event code: BCS-GHØØ2-5×ACS-GHØØ1-3, gene: bar, e.g. commercially available as GlyTol™ Liberty Link™), GHB614×T304-40×GHB119 (event code: BCS-GH002-5×BCS-GHØØ4-7×BCS-GHØØ5-8, gene: bar, e.g. commercially available as Glytol™×Twinlink™) LLCotton25 (event code: ACS-GHØØ1-3, gene: bar, e.g. commercially available as ACS-GHØØ1-3), GHB614×T304-40×GHB119×COT102 (event code: BCS-GHØØ2-5×BCS-GHØØ4-7×BCS-GHØØ5-8×SYN-IR1Ø2-7, gene: bar, e.g. commercially available as Glytol™×Twinlink™×VIPCOT™ Cotton), LLCotton25×MON15985 (event code: ACS-GHØØ1-3×MON-15985-7, gene: bar, e.g. commercially available as Fibermax™ Liberty Link™ Bollgard II™), T304-40×GHB119 (event code: BCS-GHØØ4-7×BCS-GHØØ5-8, gene: bar, e.g. commercially available as TwinLink™ Cotton), GHB614×T304-40×GHB119×COT102 (event code: BCS-GHØØ2-5×BCS-GHØØ4-7×BCS-GHØØ5-8×SYN-IR1Ø2-7, gene: bar, e.g. commercially available as Glytol™×Twinlink™×VIPCOT™ Cotton), GHB119 (event code: BCS-GHØØ5-8, gene: bar), GHB614×LLCotton25×MON15985 (event code: CS-GHØØ2-5×ACS-GHØØ1-3×MON-15985-7, gene: bar), MON 88701-3 (event code: MON88701, gene: bar), T303-3 (event code: BCS-GHØØ3-6, gene: bar), T304-40 (event code: BCS-GHØØ3-6, gene: bar), (event code: BCS-GHØØ4-7, gene: bar), 81910 (event code: DAS-81910-7, gene: pat), MON8870 (event code: MON 887Ø1-3, gene: bar), MON88701×MON88913 (event code: MON 887Ø1-3×MON-88913-8, gene: bar), MON88701×MON88913×MON15985 (event code: MON 887Ø1-3×MON-88913-8×MON-15985-7, gene: bar), 281-24-236×3006-210-23×COT102×81910 (event code: DAS-24236-5×DAS-21Ø23-5×SYN-IR1Ø2-7×DAS-81910-7, gene: pat), COT102×MON15985×MON88913×MON88701 (event code: SYN-IR1Ø2-7×MON-15985-7×MON-88913-8×MON 887Ø1-3, gene: bar) and 3006-210-23×281-24-236×MON88913×COT102×81910 (event code: DAS-21Ø23-5×DAS-24236-5×MON-88913-8×SYN-IR1Ø2-7×DAS-81910-7, gene: pat).

Transgenic canola events comprising glufosinate tolerance genes are for example, but not excluding others, HCN10 (Topas 19/2) (event code: gene: bar, e.g. commercially available as Liberty Link™ Independence™), HCN28 (T45) (event code: ACS-BNØØ8-2, gene: pat, e.g. commercially available as InVigor™ Canola), HCN92 (Topas 19/2 (event code: ACS-BNØØ7-1, gene: bar, e.g. commercially available as Liberty Link™ Innovator™), MS1 (B91-4) (event code: ACS-BNØØ4-7, gene: bar, e.g. commercially available as InVigor™ Canola), MS1×RF1 (PGS1) (event code: ACS-BNØØ4-7×ACS-BNØØ1-4, gene: bar, e.g. commercially available as InVigor™ Canola), MS1×RF2 (PGS2) (event code: ACS-BNØØ4-7×ACS-BNØØ2-5, gene: bar, e.g. commercially available as InVigor™ Canola), MS1×RF3 (event code: ACS-BNØØ4-7×ACS-BNØØ3-6, gene: bar, e.g. commercially available as InVigor™ Canola), MS8 (event code: ACS-BNØØ5-8, gene: bar, e.g. commercially available as InVigor™ Canola), MS8×RF3 (event code: ACS-BNØØ5-8×ACS-BNØØ3-6, gene: bar, e.g. commercially available as InVigor™ Canola), RF1 (B93-101) (event code: ACS-BNØØ1-4, gene: bar, e.g. commercially available as InVigor™ Canola), RF2 (B94-2) (event code: ACS-BNØØ2-5, gene: bar, e.g. commercially available as InVigor™ Canola), RF3 (event code: ACS-BNØØ3-6, gene: bar, e.g. commercially available as InVigor™ Canola), MS1×MON88302 (event code: ACS-BNØØ4-7×MON-88302-9, gene: bar, e.g. commercially available as InVigor™×TruFlex™ Roundup Ready™ Canola), MS8×MON88302 (event code: ACS-BNØØ5-8×MON-883Ø2-9, gene: bar, e.g. commercially available as InVigor™×TruFlex™ Roundup Ready™ Canola), RF1×MON88302 (event code: ACS-BNØØ1-4×MON-883Ø2-9, gene: bar, e.g. commercially available as InVigor™×TruFlex™ Roundup Ready™ Canola), RF2×MON88302 (event code: ACS-BNØØ2-5×MON-883Ø2-9, gene: bar, e.g. commercially available as InVigor™×TruFlex™ Roundup Ready™ Canola), HCN28×MON88302 (event code: ACS-BNØØ8-2×MON-883Ø2-9, gene: pat, e.g. commercially available as InVigor™×TruFlex™ Roundup Ready™ Canola), HCN92×MON88302 (event code: ACS-BNØØ7-1×MON-883Ø2-9, gene: bar, e.g. commercially available as Liberty Link™ Innovator™×TruFlex™ Roundup Ready™ Canola), HCR-1 (gene: pat), MON88302×MS8×RF3 (event code: MON-883Ø2-9×ACS-BNØØ5-8×ACS-BN003-6, gene: bar), MON88302×RF3 (event code: MON-883Ø2-9×ACS-BNØØ3-6, gene: bar), MS8×RF3×GT73 (RT73) (event code: gene: bar), PHY14 (event code: ACS-BNØØ5-8×ACS-BNØØ3-6×MON-ØØØ73-7, gene: bar), PHY23 (gene: bar), PHY35 (gene: bar) and PHY36 (gene: bar) and 73496×RF3 (event code: DP-Ø73496-4×ACS-BNØØ3-6, gene: bar).

Transgenic rice events comprising glufosinate tolerance genes are for example, but not excluding others, LLRICE06 (event code: ACS-OSØØ1-4, e.g. commercially available as Liberty Link™ rice), LLRICE601 (event code: BCS-OSØØ3-7, e.g. commercially available as Liberty Link™ rice) and LLRICE62 (event code: ACS-OSØØ2-5, e.g. commercially available as Liberty Link™ rice).

The herbicidal compositions have an outstanding herbicidal activity against a broad spectrum of economically important harmful monocotyledonous and dicotyledonous harmful plants. Also here, post-emergence application is preferred.

Specifically, examples may be mentioned of some representatives of the monocoty-ledonous and dicotyledonous weed flora which can be controlled by the combinations according to the invention, without the enumeration being a restriction to certain species.

In the context of the present text, reference may be made to growth stages according to the BBCH monograph “Growth stages of mono- and dicotyledonous plants”, 2nd edition, 2001, ed. Uwe Meier, Federal Biological Research Centre for Agriculture and Forestry (Biologische Bundesanstalt für Land und Forstwirtschaft).

Examples of monocotyledonous harmful plants on which the glufosinate combinations act efficiently are from amongst the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Particular examples of monocotyledonous harmful plants species on which the herbicidal compositions act efficiently are selected from amongst the species Hordeum murinum, Echinochloa crus-galli, Poa annua, Bromus rubens L., Bromus rigidus, Bromus secalinus L., Digitaria sanguinalis, Digitaria insularis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

In a preferred embodiment, the herbicidal compositions are used to control monocoty-ledonous harmful plant species, more preferably monocoty-ledonous plants of the species Echinochloa spp., Digitaria spp., Setaria spp., Eleusine spp. and Bra-chiarium spp.

Examples of dicotyledonous harmful plants on which the herbicidal compositions act efficiently are from amongst the genera Amaranthus spp., Erigeron spp., Conyza spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Particular examples of dicotyledonous harmful plants species on which the herbicidal compositions act efficiently are selected from amongst the species Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis (Conyza bonariensis), Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Sida spinosa, Portulaca oleracea, Richardia scabra, Ambrosia artemisiifolia, Calandrinia cau-lescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Vicia ben-ghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

In a preferred embodiment, the herbicidal compositions are used to control dicotyledonous harmful plant species, more preferably dicotyledonous plants of the species Amaranthus spp., Erigeron spp., Conyza spp., Kochia spp. and Abutilon spp.

Herbicidal compositions are also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), Cyperus difformis, Cyperus difformis L., Cyperus esculentus, Cyperus ferax, Cyperus flavus, Cyperus iria, Cyperus lanceolatus, Cyperus odoratus, Cyperus rotundus, Cyperus serotinus Rottb., Eleocharis acicularis, Eleocharis kuroguwai, Fimbristylis dichotoma, Fimbristylis miliacea, Scirpus grossus, Scirpus juncoides, Scirpus juncoides Roxb, Scirpus or Bolboschoenus maritimus, Scirpus or Schoenoplectus mucronatus, Scirpus planiculmis Fr. Schmidt and the like.

If the herbicidal compositions are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crops, is eliminated at a very early point in time and in a sustained manner.

The herbicidal compositions are characterized by a rapidly commencing and long-lasting herbicidal action. As a rule, the rainfastness of the active compounds in the herbicide combinations according to the present invention is advantageous. In particular when the herbicidal compositions are employed application rates may be reduced, a broader spectrum of broad-leaved weeds and grass weeds maybe controlled, the herbicidal action may take place more rapidly, the duration of action may be longer, the harmful plants may be controlled better while using only one, or few, applications, and the application period which is possible to be extended.

The abovementioned properties and advantages are of benefit for weed control practice to keep agricultural crops free from undesired competing plants and thus to safeguard and/or increase the yields from the qualitative and/or quantitative point of view. These herbicidal compositions markedly exceed the technical state of the art with a view to the properties described. Owing to their herbicidal and plant-growth-regulatory properties, the herbicidal compositions can be employed for controlling harmful plants in genetically modified crops or crops obtained by mutation/selection. These crops are distinguished as a rule by particular, advantageous properties, such as resistances to herbicidal compositions or resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

The present invention also relates to a method of controlling undesired vegetation (e.g. harmful plants), which comprises applying the herbicidal compositions, preferably by the post-emergence method, to harmful or undesired plants, parts of said harmful or undesired plants, or the area where the harmful or undesired plants grow, for example the area under cultivation. In the context of the present invention “controlling” denotes a significant reduction of the growth of the harmful plant(s) in comparison to the untreated harmful plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

Thus, in a further aspect, the present invention relates to a method for controlling undesired plant growth, and/or controlling harmful plants, comprising the step of applying the herbicidal composition (preferably in one of the preferred embodiments defined herein) onto the undesired plants or the harmful plants, on parts of the undesired plants or the harmful plants, or on the area where the undesired plants or the harmful plants grow.

The herbicidal composition(s) may be used for controlling undesirable vegetation in burndown programs, in industrial vegetation management and forestry, in vegetable and perennial crops and in turf and lawn, wherein the herbicidal composition(s) can be applied pre- or post-emergence, i.e. before, during and/or after emergence of the undesirable plants. Preferred is the application as post-emergence treatment, i.e. during and/or after emergence of the undesirable plants. Herein, the herbicidal composition(s) are applied to a locus where crops will be planted before planting or emergence of the crop.

In industrial weed management and forestry, it is desirable to control a broad range of weeds for an extended period of time. The control of large weeds, or taller species such as bushes or trees may also be desirable. Industrial weed management includes for example railway and right-of-way management, fence lines and non-crop land such as industrial and building sites, gravel areas, roads or sidewalks. Forestry includes for example the clearing of existing forest or bushland, the removal of regrowth after mechanical forest cutting, or the management of weeds under forestry plantations. In the latter case, it may be desirable to shield desirable trees from contact with the spray solution that contains the herbicidal mixture according to the present invention.

The herbicidal composition can also be used for weed control in turf and lawn provided the desirable grass species are tolerant to herbicidal composition. In particular, such herbicidal compositions can be used in desirable grass that has been rendered tolerant to the respective agrochemical active ingredient, e.g. glufosinate or its salts, by mutagenesis or genetic engineering.

Glufosinate and its salts are non-selective systemic herbicides having a good post-emergence activity against numerous weeds and thus can be used in burndown programs, in industrial vegetation management and forestry, in vegetable and perennial crops and in turf and lawn.

Therefore, the present invention also relates to a method for burndown treatment of undesirable vegetation in crops, comprising applying the herbicidal composition, to a locus where crops will be planted before planting (or seeding) or emergence of the crop. Herein, the herbicidal composition is applied undesirable vegetation or the locus thereof.

The present invention also relates to a method for controlling undesirable vegetation, which method comprises applying the microemulsion of the present invention, hereinafter also referred to as herbicidal composition if at least one of the pesticide A.1 or A.2 is a herbicide compound, to a locus where undesirable vegetation is present or is expected to be present. The application may be done before, during and/or after, preferably during and/or after, the emergence of the undesirable vegetation. In one embodiment, the application is carried out before emergence of the crop, which is cultivated at the locus where the undesirable vegetation is present or is expected to be present. In another embodiment, the application is carried out before planting the crop.

As used herein, the terms “controlling” and “combating” are synonyms.

As used herein, the terms “undesirable vegetation”, “undesirable species”, “undesirable plants”, “harmful plants”, “undesirable weeds”. or “harmful weeds” are synonyms.

The term “locus”, as used herein, means the area in which the vegetation or plants are growing or will grow, typically a field.

In burndown programs, the herbicidal composition(s) can be applied prior to seeding (planting) or after seeding (or planting) of the crop plants but before the emergence of the crop plants, in particular prior to seeding. The herbicidal compositions are preferably applied prior to seeding of the crop plants. For burndown, the herbicidal composition(s) will generally be applied a date up to 9 months, frequently up to 6 months, preferably up to 4 months prior to planting the crop. The burndown application can be done at a date up to 1 day prior to emergence of the crop plant and is preferably done at a date prior to seeding/planting of the crop plant, preferably at a date of at least one day, preferably at least 2 days and in particular at least one 4 days prior to planting or from 6 months to 1 day prior emergence, in particular from 4 months to 2 days prior emergence and more preferably from 4 months to 4 days prior emergence. It is, of course, possible to repeat the burndown application once or more, e.g. once, twice, three times, four times or five times within that time frame.

It is a particular benefit of the herbicidal compositions that they have a very good post-emergence herbicide activity, i.e. they show a good herbicidal activity against emerged undesirable plants. Thus, in a preferred embodiment of invention, the herbicidal compositions are applied post-emergence, i.e. during and/or after, the emergence of the undesirable plants. It is particularly advantageous to apply the herbicidal composition post emergent when the undesirable plant starts with leaf development up to flowering. The herbicidal compositions are particularly useful for controlling undesirable vegetation which has already developed to a state, which is difficult to control with conventional burndown mixtures, i.e. when the individual weed is taller than 10 cm (4 inches) or even taller than 15 cm (6 inches) and/or for heavy weed populations. In the case of a post-emergence treatment of the plants, the herbicidal compositions are preferably applied by foliar application.

The herbicidal compositions can be applied in conventional manner by using techniques as skilled person is familiar with. Suitable techniques include spraying, atomizing, dusting, spreading or watering. The type of application depends on the intended purpose in a well-known manner; in any case, they should ensure the finest possible distribution of the active ingredients according to the invention.

In one embodiment, the herbicidal compositions are applied to locus mainly by spraying, in particular foliar spraying of an aqueous dilution of the active ingredients of the mixture. Application can be carried out by customary spraying techniques using, for example, water as carrier and spray liquor rates of from about 10 to 2000 l/ha or 50 to 1000 l/ha (for example from 100 to 500 l/ha). Application of the inventive mixtures by the low-volume and the ultra-low-volume method is possible, as is their application in the form of microgranules.

The required application rate of the herbicidal composition depends on the density of the undesired vegetation, on the development stage of the plants, on the climatic conditions of the location where the mixture is used and on the application method.

In general, the rate of application of L-glufosinate or its salt is usually from 50 g/ha to 3000 g/ha and preferably in the range from 100 g/ha to 2000 g/ha or from 200 g/ha to 1500 g/ha of active substance (a.i.).

When using the herbicidal composition in the methods of the present invention, the glufosinate or a salt thereof and the compound of formula (I) can be applied simultaneously or in succession, where undesirable vegetation may occur. Herein, it is immaterial whether the individual compounds present in the inventive mixtures are formulated jointly or separately and applied jointly or separately, and, in the case of separate application, in which order the application takes place. It is only necessary, that the individual compounds present in the inventive mixtures are applied in a time frame, which allows simultaneous action of the active ingredients and/or the compound of formula (I) on the undesirable plants.

The herbicidal compositions show a persistent herbicidal activity, even under difficult weathering conditions, which allows a more flexible application in burndown applications and minimizes the risk of weeds escaping. Apart from that, the herbicidal compositions show superior crop compatibility with certain conventional crop plants and with herbicide tolerant crop plants, i.e. their use in these crops leads to a reduced damage of the crop plants and/or does not result in increased damage of the crop plants. Thus, the herbicidal compositions can also be applied after the emergence of the crop plants. The herbicidal compositions may also show an accelerated action on harmful plants, i.e. they may affect damage of the harmful plants more quickly.

The herbicidal compositions are also suitable for controlling weeds that are resistant to commonly used herbicides such as, for example, weeds that are resistant to glyphosate, weeds that are resistant to auxin inhibitor herbicides such as e. g. 2,4-D or dicamba, weeds that are resistant to photosynthesis inhibitors such as e. g. atrazine, weeds that are resistant to ALS inhibitors such as e. g. sulfonylureas, imidazolinones or triazolopyrimidines, weeds that are resistant to ACCase inhibitors such as e. g. clodinafop, clethodim or pinoxaden or weeds that are resistant to protoporphyrinogen-IX-oxidase inhibitors such as e. g. sulfentrazone, flumioxazine, fomesafen or acifluorfen, for example the weeds that are listed in the International Survey of Resistant Weeds (http://www.weedscience.org/Summary/SpeciesbySOATable.aspx). In particular, they are suitable for controlling the resistant weeds that are resistant go glufosinate or its salts, such as listed in the International Survey of Resistant Weeds, for example ACCase resistant Echinochloa crus-galli, Avena fatua, Alopecurus myosuroides, Echinochloa colona, Alopecurus japonicus, Bromus tectorum, Hordeum murinum, Ischaemum rugosum, Setaria viridis, Sorghum halepense, Alopecurus aequalis, Apera spica-venti, Avena sterilis, Beckmannia szygachne, Bromus diandrus, Digitaria sanguinalis, Echinocloa oryzoides, Echinochloa phyllopogon, Phalaris minor, Phalaris paradoxa, Setaria faberi, Setaria viridis, Brachypodium distachyon, Bromus diandrus, Bromus sterilis, Cynosurus echinatus, Digitaria insularis, Digitaria ischaemum, Leptochloa chinensis, Phalaris brachystachis, Rotboellia cochinchinensis, Digitaria ciliaris, Ehrharta longiflora, Eriochloa punctata, Leptochloa panicoides, Lolium persicum, Polypogon fugax, Sclerochloa kengiana, Snowdenia polystacha, Sorghum sudanese and Brachiaria plantaginea, ALS inhibitor resistant Echinochloa crus-galli, Poa annua, Avena fatua, Alopecurus myosuroides, Echinochloa colona, Amaranthus hybridus, Amaranthus palmeri, Amaranthus rudis, Conyza sumatrensis, Amaranthus retroflexus, Ambrosia artemisifolia, Conyza canadensis, Kochia scoparia, Raphanus raphanistrum, Senecio vernalis, Alopecurus japonicus, Bidens pilosa, Bromus tectorum, Chenopodium album, Conyza bonariensis, Hordeum murinum, Ischaemum rugosum, Senecio vulgaris, Setaria viridis, Sisymbrium orientale, Sorghum halepense, Alopecurus aequalis, Amaranthus blitum, Amaranthus powellii, Apera spica-venti, Avena sterilis, Brassica rapa, Bromus diandrus, Descurainia sophia, Digitaria sanguinalis, Echinochloa oryzoides, Echinochloa phyllopogon, Euphorbia heterophylla, Lactuca serriola, Phalaris minor, Phalaris paradoxa, Setaria faberi, Setaria viridis, Sinapis arvensis, Solanum ptycanthum, Sonchus oleraceus, Stellaria media, Amaranthus blitoides, Amaranthus spinosus, Amaranthus viridis, Ambrosia trifida, Bidens subalternans, Bromus diandrus, Bromus sterilis, Capsella bursa pastoris, Centaurea cyanus, Cynosurus echinatus, Cyperus difformis, Fimbristilis miliacea, Galeopsis tetrahit, Galium aparine, Galium spurium, Helianthus annuus, Hirschfeldia incana, Limnocharis flava, Limnophila erecta, Papaver rhoeas, Parthenium hysterophorus, Phalaris brachystachis, Polygonum convolvulus, Polygonum lapathifolium, Polygonum persicaria, Ranunculus acris, Rottboellia cochinchinensis, Sagittaria montevidensis, Salsola tragus, Schoenoplectus mucronatus, Setaria pumila, Sonchus asper, Xanthium strumarium, Ageratum conyzoides, Alisma canaliculatum, Alisma plantago-aquatica, Ammannia auriculata, Ammannia coccinea, Ammannia arvensis, Anthemis cotula, Bacopa rotundifolia, Bifora radians, Blyxa aubertii, Brassica tournefortii, Bromus japonicus, Bromus secalinus, Lithospermum arvense, Camelina microcarpa, Chamaesyce maculata, Chrysanthemum coronarium, Clidemia hirta, Crepis tectorum, Cuscuta pentagona, Cyperus brevifolis, Cyperus compressus, Cyperus esculentus, Cyperus iria, Cyperus odoratus, Damasonium minus, Diplotaxis erucoides, Diplotaxis tenuifolia, Dopatrum junceum, Echium plantagineum, Elatine triandra, Eleocharis acicularis, Erucaria hispanica, Erysimum repandum, Galium tricornutum, Iva xanthifolia, Ixophorus unisetus, Lamium amplexicaule, Limnophilia sessiliflora, Lindernia dubia, Lindernia micrantha, Lindernia procumbens, Ludwigia prostrata, Matricaria recutita, Mesembryanthemum crystallinum, Monochoria korsakowii, Monochoria vaginalis, Myosoton aquaticum, Neslia paniculata, Oryza sativa var. sylvatica, Pentzia suffruticosa, Picris hieracioides, Raphanus sativus, Rapistrum rugosum, Rorippa indica, Rotala indica, Rotala pusilla, Rumex dentatus, Sagittaria guayensis, Sagittaria pygmaea, Sagittaria trifolia, Schoenoplectus fluviatilis, Schoenoplectus juncoides, Schoenoplectus wallichii, Sida spinosa, Silene gallica, Sinapis alba, Sisymbrium thellungii, Sorghum bicolor, Spergula arvensis, Thlaspi arvense, Tripleurospermum perforatum, Vaccaria hispanica and Vicia sativa, photosynthesis inhibitor resistant Echinochloa crus-galli, Poa annua, Alopecurus myosuroides, Echinochloa colona, Amaranthus hybridus, Amaranthus palmeri, Amaranthus rudis, Conyza sumatrensis, Amaranthus retroflexus, Ambrosia artemisifolia, Conyza canadensis, Kochia scoparia, Raphanus raphanistrum, Senecio vernalis, Alopecurus japonicus, Bidens pilosa, Bromus tectorum, Chenopodium album, Conyza bonariensis, Ischaemum rugosum, Senecio vulgaris, Setaria viridis, Sisymbrium orientale, Amaranthus blitum, Amaranthus powellii, Apera spica-venti, Beckmannia syzigachne, Brassica rapa, Digitaria sanguinalis, Euphorbia heterophylla, Phalaris minor, Phalaris paradoxa, Setaria faberi, Setaria viridis, Sinapis arvensis, Solanum ptycanthum, Stellaria media, Amaranthus blitoides, Amaranthus viridis, Bidens subalternans, Brachypodium distachyon, Capsella bursa-pastoris, Chloris barbata, Cyperus difformis, Echinochloa erecta, Epilobium ciliatum, Polygonum aviculare, Polygonum convolvulus, Polygonum lapathifolium, Polygonum persicaria, Portulaca oleracea, Schoenoplectus mucronatus, Setaria pumila, Solanum nigrum, Sonchus asper, Urochloa panicoides, Vulpia bromoides, Abutilon theophrasti, Amaranthus albus, Amaranthus cruentus, Arabidopsis thaliana, Arenaria serpyllifolia, Bidens tripartita, Chenopodium album, Chenopodium ficifolium, Chenopodium polyspermum, Crypsis schoenoides, Datura stramonium, Epilobium tetragonum, Galinsoga ciliata, Matricaria discoidea, Panicum capillare, Panicum dichotomiflorum, Plantago lagopus, Polygonum hydopiper, Polygonum pensylvanicum, Polygonum monspeliensis, Rostraria, smyrnacea, Rumex acetosella, Setaria verticillata and Urtica urens, PS-I-electron diversion inhibitor resistant Poa annua, Conyza sumatrensis, Conyza canadensis, Alopecurus japonicus, Bidens pilosa, Conyza bonariensis, Hordeum murinum, Ischaemum rugosum, Amaranthus blitum, Solanum ptycanthum, Arctotheca calendula, Epilobium ciliatum, Hedyotis verticillata, Solanum nigrum, Vulpia bromoides, Convolvulus arvensis, Crassocephalum crepidioides, Cuphea carthagensis, Erigeron philadelphicus, Gamochaeta pensylvanica, Landoltia punctata, Lepidium virginicum, Mazus fauriei, Mazus pumilus, Mitracarpus hirtus, Sclerochloa dura, Solanum ameri canum and Youngia japonica, glyphosate resistant Poa annua, Echinochloa colona, Amaranthus hybridus, Amaranthus palmeri, Amaranthus rudis, Conyza sumatrensis, Ambrosia artemisifolia, Conyza canadensis, Kochia scoparia, Raphanus raphanistrum, Bidens pilosa, Conyza bonariensis, Hordeum murinum, Sorghum halepense, Brassica rapa, Bromus diandrus, Lactuca serriola, Sonchus oleraceus, Amaranthus spinosus, Ambrosia trifida, Digitaria insularis, Hedyotis verticillata, Helianthus annuus, Parthenium hysterophorus, Plantago lanceolata, Salsola tragus, Urochloa panicoides, Brachiaria eruciformis, Bromus rubens, Chloris elata, Chloris truncata, Chloris virgata, Cynodon hirsutus, Lactuca saligna, Leptochloa virgata, Paspalum panicu latum and Tridax procumbens, microtubule assembly inhibitor resistant Echinochloa crus-galli, Poa annua, Avena fatua, Alopecurus myosuroides, Amaranthus palmeri, Setaria viridis, Sorghum halepense, Alopecurus aequalis, Beckmannia syzigachne and Fumaria densifloria, auxin herbicide resistant Echinochloa crus-galli, Echinochloa colona, Amaranthus hybridus, Amaranthus rudis, Conyza sumatrensis, Kochia scoparia, Raphanus raphanistrum, Chenopodim album, Sisymbrium orientale, Descurainia sophia, Lactuca serriola, Sinapis arvensis, Sonchus oleraceus, Stellaria media, Arctotheca calendula, Centaurea cyanus, Digitaria ischaemum, Fimbristylis miliacea, Galeopsis tetrahit, Galium aparine, Galium spurium, Hirschfeldia incana, Limnocharis flava, Limnocharis erecta, Papaver rhoeas, Plantago lanceolata, Ranunculus acris, Carduus nutans, Carduus pycnocephalus, Centaurea soltitialis, Centaurea stoebe ssp. Micranthos, Cirsium arvense, Commelina diffusa, Echinochloa crus-pavonis, Soliva sessilis and Sphenoclea zeylanica, HPPD inhibitor resistant Amaranthus palmeri and Amaranthus rudis, PPO inhibitor resistant Acalypha australis, Amaranthus hybridus, Amaranthus palmeri, Amaranthus retroflexus, Amaranthus rudis, Ambrosia artemisifolia, Avena fatua, Conyza sumatrensis, Descurainia sophia, Euphorbia heterophylla and Senecio vernalis, carotenoid biosynthesis inhibitor resistant Hydrilla verticillata, Raphanus raphanistrum, Senecio vernalis and Sisymbrium orientale, VLCFA inhibitor resistant Alopecurus myosuroides, Avena fatua and Echinochloa crus-galli.

The herbicidal compositions are suitable for combating/controlling common harmful plants in fields, where useful plants shall be planted (i.e. in crops). The inventive mixtures are generally suitable, such as for burndown of undesired vegetation, in fields of the following crops:

Grain crops, including e.g. cereals (small grain crops) such as wheat (Triticum aestivum) and wheat like crops such as durum (T. durum), einkorn (T. monococcum), emmer (T. dicoccon) and spelt (T. spelta), rye (Secale cereale), triticale (Tritiosecale), barley (Hordeum vulgare); maize (corn; Zea mays); sorghum (e.g. Sorghum bicolour); rice (Oryza spp. such as Oryza sativa and Oryza glaberrima); and sugar cane;

Legumes (Fabaceae), including e.g. soybeans (Glycine max.), peanuts (Arachis hypogaea and pulse crops such as peas including Pisum sativum, pigeon pea and cowpea, beans including broad beans (Vicia faba), Vigna spp., and Phaseolus spp. and lentils (Lens culinaris var.);

brassicaceae, including e.g. canola (Brassica napus), oilseed rape (OSR, Brassica napus), cabbage (B. oleracea var.), mustard such as B. juncea, B. campestris, B. narinosa, B. nigra and B. tournefortii; and turnip (Brassica rapa var.);

other broadleaf crops including e.g. sunflower, cotton, flax, linseed, sugarbeet, potato and tomato;

TNV-crops (TNV: trees, nuts and vine) including e.g. grapes, citrus, pomefruit, e.g. apple and pear, coffee, pistachio and oilpalm, stonefruit, e.g. peach, almond, walnut, olive, cherry, plum and apricot;

turf, pasture and rangeland;

onion and garlic;

bulb ornamentals such as tulips and narcissus;

conifers and deciduous trees such as pinus, fir, oak, maple, dogwood, hawthorne, crabapple, and rhamnus (buckthorn); and

garden ornamentals such as roses, petunia, marigold and snapdragon.

In one embodiment, the method for controlling undesired vegetation is applied in cultivated rice, maize, pulse crops, cotton, canola, small grain cereals, soybeans, peanut, sugarcane, sunflower, plantation crops, tree crops, nuts or grapes. In another embodiment, the method is applied in cultivated crops selected from glufosinate-tolerant crops.

The herbicidal compostions of the present invention are in particular suitable for burndown of undesired vegetation in fields of the following crop plants: small grain crops such as wheat, barley, rye, triticale and durum, rice, maize (corn), sugarcane, sorghum, soybean, pulse crops such as pea, bean and lentils, peanut, sunflower, sugarbeet, potato, cotton, brassica crops, such as oilseed rape, canola, mustard, cabbage and turnip, turf, pasture, rangeland, grapes, pomefruit, such as apple and pear, stonefruit, such as peach, almond, walnut, pecans, olive, cherry, plum and apricot, citrus, coffee, pistachio, garden ornamentals, such as roses, petunia, marigold, snap dragon, bulb ornamentals such as tulips and narcissus, conifers and deciduous trees such as pinus, fir, oak, maple, dogwood, hawthorne, crabapple and rhamnus.

The herbicidal compositions are most suitable for burndown of undesired vegetation in fields of the following crop plants: small grain crops such as wheat, barley, rye, triticale and durum, rice, maize, sugarcane, soybean, pulse crops such as pea, bean and lentils, peanut, sunflower, cotton, brassica crops, such as oilseed rape, canola, turf, pasture, rangeland, grapes, stonefruit, such as peach, almond, walnut, pecans, olive, cherry, plum and apricot, citrus and pistachio.

### EXAMPLES

The following tables show examples illustrating the invention

I. Components of the Microemulsion Compositions

TABLE C
Ingredients of the microemulsion according to the present invention:

| | | Product (commercially |
|---|---|---|
| | | available or individually |
| | | formulated for composition |
| Components | Chemical | examples) |
| A. Herbicides | | |
| Water soluble | Glufosinate-Ammonium | Active ingredient |
| herbicide A.1 | | |
| Water insoluble | Dimethenamid-P | Active ingredient |
| herbicide A.2 | | |
| B. Organosulfate | | |
| surfactant | | |
| | organosulfate surfactants B.1 | |
| B.1a | Sodium Laurylether sulfate | R—O—(CH₂CH₂O)x—SO₃⁻⁺Na |
| | (described as a 100% in | R = Liner, saturated C₁₂—C₁₄ |
| | composition examples below)* | fatty alcohol |
| | Molecular weight: 382 g/mol | X = approx. 2 |
| | | (Available as a commercial |
| | | product Agnique ® SLES 370 |
| | | 70% w/w in Water) |
| B.1b | 2-hydroxypropyl ammonium | R—O—(CH₂CH₂O)x—SO₃⁻⁺NH₃CH₂CH(OH)CH₃ |
| | Laurylether sulfate | R = Liner, saturated C₁₂—C₁₄ |
| | (described as a 100% in | fatty alcohol |
| | composition examples below)* | X = approx. 2 |
| | Molecular weight: 438 g/mol | (Available as a commercial |
| | | product Plantapon ® MP 90 |
| | | 85% w/w in monopropylene |
| | | glycole.) |
| B.1c | Monoethanolamine Laurylether sulfate | R—O—(CH₂CH₂O)x—SO₃⁻⁺NH₃CH₂CH₂OH |
| | (described as a 100% in | R = Liner, saturated C₁₂—C₁₄ |
| | composition examples below)* | fatty alcohol |
| | Molecular weight: 423 g/mol | X = approx. 2 |
| | | (prepared as 77% w/w in |
| | | Dipropylene glycole) |
| B.1d | Diethanolamine Laurylether sulfate | R—O—(CH₂CH₂O)x—SO₃⁻⁺NH₂(CH₂CH₂OH)₂ |
| | (described as a 100% in | R = Liner, saturated C₁₂—C₁₄ |
| | composition examples below)* | fatty alcohol |
| | Molecular weight: 467 g/mol | X = approx. 2 |
| | | (prepared as 77% w/w in |
| | | Dipropylene glycole) |
| | organosulfate surfactants B.2 | |
| B.2a | Diethanolamine Ethylhexyl Sulfate | DEA-EH: |
| | (described as a 100% in | diethanol amine salt of 2- |
| | composition examples below)* | ethylhexyl sulfate + 70% in |
| | Molecular weight: 315 g/mol | monopropylene glycol |
| | | (GM0057-0040) |
| | | Mwt: 315 g/mol |
| | | (prepared as 70% w/w in |
| | | Monopropylene glycole) |
| B.2b | Sodium 2-Ethylhexyl Sulfate | Available as a commercial |
| | (described as a 100% in | product Texapon ® EHS |
| | composition examples below)* | ~47% w/w in water |
| | Molecular weight: 232 g/mol | Mwt: 232 g/mol |

*all components in table C, which are either listed as commercially available product or described as formulation, are shown in table M.1 to M.4, respectively MC.1, according to their calculated final content.

Tables M.1 to M.4 show several microemulsion compositions according to the present invention, and table MC.1 show five comparative microemulsion compositions, which do not comprise the organosulfate surfactant components according to the present invention.

The microemulsions were prepared by mixing the ingredients at the concentrations as provided in the respective tables.

### I.1 Examples of Microemulsion Compositions According to the Invention

The microemulsion examples from 1 to 12 were prepared by mixing the pesticidal compound(s) with the inventive combination of laurylether sulfates salts (linear alkylether sulfate salts) as organosulfate surfactants B.1 with 2-ethylhexyl sulfate salts (branched alkyl sulfate salts) as organosulfate surfactants B.2. All microemulsions were found to be stable at 0° C., 25° C. and 50° C. (between 0 and 50° C.).
Thereby evidence is given, that when B1 type organosulfate surfactants are combined with B2 type organosulfate surfactants stable microemulsions are obtained (Examples 1-12).

TABLE M

| Ingredient [g/l] | Ex. 1 | Ex. 2 |
|---|---|---|
| Glufosinate-Ammonium | 12.6% | 12.6% |
| Dimethenamid-P | 12.6% | 12.6% |
| Organosulfate surfactant | 12.3% | 12.3% |
| B.1c | | |
| Organosulfate surfacant B.2a | | 22.7% |
| Organosulfate surfacant B.2b | 16.8% | |
| Soprophor BSU | 2.2% | 2.2% |
| Tristyrylphenol ethoxylate | | |
| (16 EO) | | |
| Dipropyleneglycol | 3.7% | 3.7% |
| Monopropylenglycol | 10.7% | 10.7% |
| Citric Acid | 0.3% | 0.3% |
| Add Water 100% | 28.8% | 22.9% |
| Appearance at room temperature | clear solution | clear solution |
| 2 hours after preparation. | | |
| Appearance at 50° C. | clear solution | clear solution |
| after 2 weeks. | | |
| Appearance at 25° C. | clear solution | clear solution |
| Appearance at 0° C. | clear solution | clear solution |
| Ingredient [g/l] | Ex. 4 | Ex. 5 |
| Glufosinate-Ammonium | 12.6% | 12.6% |
| Dimethenamid-P | 12.6% | 12.6% |
| Organosulfate surfactant | 13.6% | 12.7% |
| B.1b | | |
| Organosulfate surfacant B.2b | 17.3% | 16.8% |
| Soprophor BSU | 2.2% | 2.2% |
| Tristyrylphenol ethoxylate | | |
| (16 EO) | | |
| Monopropylenglycol | 13.6% | 10.7% |
| Citric Acid | 0.3% | 0.3% |
| Add Water 100% | 27.8% | 32.1% |
| Appearance at room temperature | clear solution | clear solution |
| 2 hours after preparation. | | |
| Appearance at 50° C. | clear solution | clear solution |
| after 2 weeks. | | |
| Appearance at 25° C. | clear solution | clear solution |
| after 2 weeks. | | |
| Appearance at 0° C. | clear solution | clear solution |
| after 2 weeks. | | |

TABLE M.3

| Ingredient [g/l] | Ex. 3 | Ex. 6 | Ex. 7 | Ex. 12 |
|---|---|---|---|---|
| Glufosinate-Ammonium | 12.6% | 11.5% | 11.5% | 12.6% |
| Dimethenamid-P | 12.6% | 11.5% | 11.5% | 12.6% |
| Organosulfate surfactant B.1d | 13.7% | 9.5% | 9.5% | 13.6% |
| Organosulfate surfacant B.2a | | 23.4% | | |
| Organosulfate surfacant B.2b | 16.8% | | 17.3% | 16.0% |
| Soprophor BSU | 2.2% | 1.7% | 1.7% | 1.7% |
| Tristyrylphenol ethoxylate | | | | |
| (16 EO) | | | | |
| Dipropyleneglycol | 4.0% | 2.8% | 2.8% | 4.0% |
| Monopropylenglycol | 10.7% | 12.2% | 9.5% | 9.5% |
| Citric Acid | 0.3% | 0.3% | 0.3% | 0.3% |
| Add Water 100% | 27.1% | 27.1% | 35.9% | 29.7% |
| Appearance at room temperature | clear solution | clear solution | clear solution | clear solution |
| 2 hours after preparation. | | | | |
| Appearance at 50° C. | clear solution | clear solution | clear solution | clear solution |
| after 2 weeks. | | | | |
| Appearance at 25° C. | clear solution | clear solution | clear solution | clear solution |
| after 2 weeks. | | | | |
| Appearance at 0° C. | clear solution | clear solution | clear solution | clear solution |
| after 2 weeks. | | | | |

TABLE M

| Ingredient [g/l] | Ex. 8 | Ex. 9 |
|---|---|---|
| Glufosinate-Ammonium | 11.5% | 11.5% |
| Dimethenamid-P | 11.5% | 11.5% |
| Organosulfate surfactant B.1a | 7.8% | 7.8% |
| Organosulfate surfacant B.2a | 23.4% | |
| Organosulfate surfacant B.2b | | 17.3% |
| Soprophor BSU | 2.2% | 2.2% |
| Tristyrylphenol ethoxylate (16 EO) | | |
| Monopropylenglycol | 12.2% | 9.5% |
| Citric Acid | 0.3% | 0.3% |
| Add Water 100% | 31.1% | 39.9% |
| Appearance at room temperature 2 | clear solution | clear solution |
| hours after preparation. | | |
| Appearance at 50° C. after 2 weeks. | clear solution | clear solution |
| Appearance at 25° C. | clear solution | clear solution |
| Appearance at 0° C. | clear solution | clear solution |
| Ingredient [g/l] | Ex. 10 | Ex. 11 |
| Glufosinate-Ammonium | 12.6% | 12.6% |
| Dimethenamid-P | 12.6% | 12.6% |
| Organosulfate surfactant B.1a | 12.2% | 13.0% |
| Organosulfate surfacant B.2a | | |
| Organosulfate surfacant B.2b | 20.5% | 19.0% |
| Soprophor BSU | 2.2% | 2.2% |
| Tristyrylphenol ethoxylate (16 EO) | | |
| Monopropylenglycol | 9.5% | 11.2% |
| Citric Acid | 0.3% | 0.3% |
| Add Water 100% | 30.1% | 29.1% |
| Appearance at room temperature 2 | clear solution | clear solution |
| hours after preparation. | | |
| Appearance at 50° C. after 2 weeks. | clear solution | clear solution |
| Appearance at 25° C. after 2 weeks. | clear solution | clear solution |
| Appearance at 0° C. after 2 weeks. | clear solution | clear solution |

### I.2 Comparative Examples of Microemulsion Compositions (not Falling Under the Invention)

The comparative examples 1-3 were prepared by exchanging B.2b (sodium 2-ethylhexyl sulfate) with other surfactants, which comprise sulfonic acid groups (p-Tolunesulfonic acid, 4-dodecylbenzensulfonic acid, and alkylbenzenesulfonic acid C₁₀-C₁₃ with a molecular weight of 332 g/Mole [MARANIL® DES] respectively). Those acids were neutralized with monoethanolamine to increase the solubility of the surfactants in their salt form in the water similar to sodium 2-ethylhexylsulfate. The comparative compositions 1 to 3 did provide any microemulsion (clear solutions). The replacement of 2-ethylhexyl sulfate was carried out on the mole basis in those compositions.
In comparative example 4, organosulfate surfactant B.2b (sodium 2-ethylhexyl sulfate) was replaced with a C₈-C₁₀ alkyl polyglycoside. Although it is known to have a high solubility in the solutions that comprise high content of electrolytes and it is recommended in patent literature (US patents: U.S. Pat. Nos. 8,445,406, 9,078,432) for obtaining homogenous compositions at a wide temperature range for the mixtures which contains a high content of Glufosinate ammonium, it also failed to provide stable microemulsion.
In comparative example 5, the composition of example 11 was modified by replacing the organosulfate surfactant B.2b (sodium 2-ethylhexyl sulfate) with organosulfate surfactant B.1a (sodium lauryl ether sulfate). The single usage of the organosulfate surfactant B.1a did not provide a stable microemulsion.
In comparative examples 6 and 7, the composition of example 11 was modified by replacing the organosulfate surfactant B.2b (sodium 2-ethylhexyl sulfate) either partially (comparative example 6) or completely (comparative example 7) with tristyrylphenol ethoxylate (16 EO). As can be seen in table MC.1, those mixture failed to provide stable microemulsions.

TABLE MC.1
Comparative Examples (continued on next page)

| Ingredient [g/I] | C.Ex. 1 | C.Ex. 2 | C.Ex. 3 | C.Ex. 4 | C.Ex.5 | C.Ex. 6 | C.Ex. 7 |
|---|---|---|---|---|---|---|---|
| Glufosinate-Ammonium | 12.6% | 12.6% | 12.6% | 12.6% | 12.6 | 12.60% | 12.60% |
| Dimethenamid-P | 12.6% | 12.6% | 12.6% | 12.6% | 12.6 | 12.6% | 12.6% |
| Organosulfate | 12.2% | 12.2% | 12.2% | 12.2% | 32,.0% | | |
| surfactant B.1a | | | | | | | |
| Organosulfate | 2.2% | 2.2% | 2.2% | 2.2% | | | |
| surfactant B.1c | | | | | | | |
| Organosulfate | | | | | | 13.5% | 13.5% |
| surfactant B.1d | | | | | | | |
| P-Toluensulfonic acid | 16.7% | | | | | | |
| 4-dodecylbenzenesulfonic | | 28.7% | | | | | |
| acid | | | | | | | |
| Marinil DBS Alyklbenzene | | | 29.2% | | | | |
| sulfonic acid Mwt. 332 g/L | | | | | | | |
| Agnique PG 8105 C8-10 | | | | 18.0% | | | |
| alkyl polyglycoside | | | | | | | |
| Monoethanolamine | 5.4% | 5.4% | 5.4% | | | | |
| Organosulfate | | | | | | 8.3% | |
| surfacant B.2b | | | | | | | |
| Soprophor BSU | 2.2% | 2.2% | 2.2% | 2.2% | 2.2% | 19.9% | 37.6% |
| Tristyrylphenol | | | | | | | |
| ethoxylate (16 EO) | | | | | | | |
| Dipropyleneglycol | | | | | | 4.0% | 4.0% |
| Monopropylenglycol | 9.5% | 9.5% | 9.5% | 9.5% | 11.2% | 9.5% | 9.5% |
| Citric Acid | 0.3% | 0.3% | 0.3% | 0.3% | 0.3% | 0.3% | 0.3% |
| Add Water 100% | 28.5% | 16.5% | 16.0% | 32.6% | 22.9% | 19.3% | 9.9% |
| Appearance at room | Turbid | Highly | Highly | Turbid | Turbid | Turbid | Turbid |
| temperature 2 hours | inhomo- | viscous | viscous | inhomo- | inhomo- | inhomo- | inhomo- |
| after preparation. | geneous | inhomo- | inhomo- | geneous, | geneous, | geneous | geneous |
| | mixture | geneous | geneous | mixture | highly | mixture. | mixture. |
| | | mixture | mixture | | viscous | | |
| | | | | | gel. | | |
| Appearance at 50° C. | N/A | N/A | N/A | N/A | N/A | N/A | N/A |
| after 2 weeks. | | | | | | | |
| Appearance at 25° C. | N/A | N/A | N/A | N/A | N/A | N/A | N/A |
| after 2 weeks. | | | | | | | |
| Appearance at 0° C. | N/A | N/A | N/A | N/A | N/A | N/A | N/A |
| after 2 weeks. | | | | | | | |

1. An aqueous agrochemical microemulsion comprising
(A) a combination of at least one pesticide A1 and at least one at least one pesticide A2, where
(A.1) is a water-soluble pesticide and
(A.2) is a water insoluble pesticide
and
(B) a mixture of at least two organosulfate surfactant components, wherein
(B.1) at least one organosulfate surfactant is selected from compounds of formula (I)
[R-(A)ₓ-OSO₃⁻]-M⁺ (I),
wherein
R is a linear radical selected from C₁₀-C₁₆-alkyl, C₁₀-C₁₆-alkenyl, or C₁₀-C₁₆-alkynyl, and
X is a number selected from 1 to 10;
and
(B.2) at least one organosulfate surfactant is selected from compounds of formula (II)
[R^{a}-(A)_{y}-OSO₃⁻]-M⁺ (II);
wherein
R^{a} is a branched radical selected from C₈-C₂₀-alkyl, C₈-C₂₀-alkenyl, or C₈-C₂₀-alkynyl, and
Y is 0 or a number selected from 1 to 10; and
wherein in formulae (I) and (II), independently from one another,
M⁺ is a monovalent cation selected from the group of alkali metal ions, NH₄⁺ and an ammonium salt of a primary, secondary or tertiary amine having a molecular weight of from 32 to 180 g/mol, or a mixture thereof;
A is a group of the following formula (i) 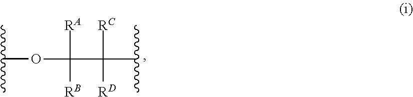
wherein
the oxygen atom in formula (i) is bound to a carbon atom in
R in formula (I), or respectively
R^{a} in formula (II); and
R^{A}, R^{B}, R^{C}, and R^{D} are selected from H, CH₃, or CH₂CH₃, with the proviso that the sum of C-atoms of R^{A}, R^{B}, R^{C}, and R^{D} is 0, 1 or 2.

2. The aqueous agrochemical microemulsion according to claim 1 comprising
(A.1) 5 to 50% by weight of the water-soluble pesticide (A.1);
(A.2) 1 to 50% by weight of the water insoluble pesticide (A.2);
(B) 5 to 70% by weight of the mixture of two organosulfate surfactant components, wherein a ratio of compounds of formula (I) to compounds of formula (II) is from 1:10 to 10:1.

3. The aqueous agrochemical microemulsion according to claim 1, wherein each of R^{A}, R^{B}, R^{C}, and R^{D} of formula (i) in at least one of the organosulfate surfactant components is hydrogen.

4. The aqueous agrochemical microemulsion according to claim 1, wherein the cation M⁺ of one or more organosulfate surfactant component is sodium, potassium or NH₄⁺ cation, or a mixture thereof.

5. The aqueous agrochemical microemulsion according to claim 1, wherein
the cation M⁺ of one or more organosulfate surfactant components is a primary, secondary, or tertiary amine having a molecular weight of from 55 to 180 g/mol, or a mixture thereof.

6. The aqueous agrochemical microemulsion according to claim 5, wherein the ammonium cation M⁺ contains exactly one nitrogen atom per molecule

7. The aqueous agrochemical microemulsion according to claim 5, wherein the ammonium cation M⁺ is of formula (ii) 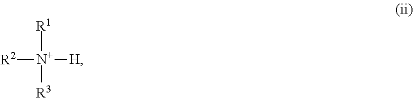
wherein
R¹, R², and R³ are selected from hydrogen or C₁-C₁₀-alkyl, which is unsubstituted or substituted with OH, C₁-C₁₀-alkoxy, or hydroxy-C₁-C₁₀-alkoxy,
with the proviso that at least one substituent R¹, R², or R³ is not hydrogen;
or wherein
two of the substituents R¹, R², or R³ form together with the N-atom to which they are bound, a 5-, or 6-membered, saturated, partially- or fully unsaturated heterocycle containing optionally and additionally independently from one another one or two atoms oxygen and/or sulfur, and wherein said S-atom(s) are independently oxidized or non-oxidized;

8. The aqueous agrochemical microemulsion according to claim 1, wherein in the organosulfate compounds of formula (II)
R^{a} is 2-ethylhexyl or 2-propylhexyl, and
y is 0, 1, 2 to 3.

9. The aqueous agrochemical microemulsion according to claim 8, wherein in the organosulfate compounds of formula (II)
R^{a} is 2-ethylhexyl or 2-propylheptyl and
y is 0.

10. The aqueous agrochemical microemulsion according to claim 1, wherein a ratio of compounds of formula (I) to compounds of formula (II) is from 1:5 to 5:1.

11. The aqueous agrochemical microemulsion according to claim 1, which additionally comprises an organic solvent which is completely miscible with water at 20° C. or has a solubility in water of at least 100 g/l at 20° C.

12. The aqueous agrochemical microemulsion according to claim 1, which additionally comprises a nonionic surfactant.

13. The aqueous agrochemical microemulsion according to claim 1,
wherein the water insoluble pesticide (A.1) has a solubility in water of less than 10 g/l, preferably less than 5 g/l.

14. The aqueous agrochemical microemulsion according to claim 1,
wherein the water-soluble pesticide (A.1) is a herbicide selected from glufosinate or a salt thereof.

15. The aqueous agrochemical microemulsion according to claim 1,
wherein the water insoluble pesticide (A.2) is a herbicide selected from the group consisting of saflufenacil, pendimethalin, atrazine, S-metolachlor, 2,4-D ester, isoxaflutole, indaziflam, diflufenzopyr, clomazone, sulfentrazone, pyroxasulam, dimethenamid-P, cinmethylin, pyroxasulfone, topramezone, mesotrione, pinoxaden, mesosulfuron, acetochlor, clethodim, propoxycarbazone, propisochlor, bentazone, clomazone, metazachlor, flumioxazin, fomesafen, aclonifen, and diflufenican.

16. The aqueous agrochemical microemulsion according to claim 1, wherein the water insoluble pesticide (A.2) is dimethenamid-P.

17. The aqueous agrochemical microemulsion according to claim 1, wherein the water insoluble pesticide (A.2) is a herbicide from the group of protoporphyrinogen oxidase inhibitors.

18. An aqueous agrochemical microemulsion comprising
(A) a combination of at least one pesticide A1 and at least one at least one pesticide A2, where
(A.1) is an herbicide selected from glufosinate or a salt thereof; and
(A.2) is dimethenamid-P;
and
(B) a mixture of at least two organosulfate surfactant components, wherein
(B.1) at least one organosulfate surfactant is selected from compounds of formula (I)
[R-(A)ₓ-OSO₃⁻]-M⁺ (I),
wherein
R is a linear radical selected from C₁₀-C₁₆-alkyl, C₁₀-C₁₆-alkenyl, or C₁₀-C₁₆-alkynyl, and
X is a number selected from 1 to 10;
and
(B.2) at least one organosulfate surfactant is selected from compounds of formula (II)
[R^{a}-(A)_{y}-OSO₃⁻]-M⁺ (II);
wherein
R^{a} is a branched radical selected from C₈-alkyl, and
Y is 0; and
wherein in formulae (I) and (II), independently from one another,
M⁺ is a monovalent cation selected from the group of alkali metal ions, NH₄⁺ and an ammonium salt of a primary, secondary or tertiary amine having a molecular weight of from 32 to 180 g/mol, or a mixture thereof;
A is a group of the following formula (i) 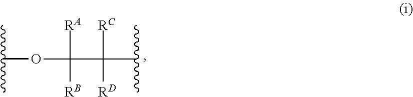
wherein
the oxygen atom in formula (i) is bound to a carbon atom in
R in formula (I), or respectively
R^{a} in formula (II); and
R^{A}, R^{B}, R^{C} and, R^{D} are selected from H, CH₃, or CH₂CH₃, with the proviso that the sum of C-atoms of R^{A}, R^{B}, R^{C}, and R^{D} is 0, 1 or 2.

19. A method for producing an aqueous agrochemical microemulsion comprising the steps of
(a) providing a water soluble pesticide (A.1),
(b) providing a water insoluble pesticide (A.2),
(c) combining two organosulfate surfactant components of compounds of formula (I), as defined in claim 1, and of formula (II), as defined in claim 1, to form a mixture (B),
(d) combining the obtained mixture (B) of the organosulfate surfactant components with the two pesticides of step (a) and (b) such that a microemulsion as defined in claim 1 is obtained.

20. A method for controlling undesired plant growth and/or controlling harmful plants, comprising applying an aqueous agrochemical microemulsion as defined in claim 14 onto the undesired plants or the harmful plants, on parts of the undesired plants or the harmful plants, or on the area where the undesired plants or the harmful plants grow.

21. (canceled)

22. (canceled)

23. The aqueous microemulsion according to claim 18 where (A1) is (L)-glufosinate or an ammonium salt thereof.
